(19) United States
(12) Patent Application Publication
(10) Pub. No.: US 2019/0157708 A1
(43) Pub. Date: May 23, 2019

(54) Lithium Battery Formation Fixture and Automation Battery Formation Equipment

(71) Applicant: Shenzhen Newpower Automation Equipment Co., LTD., Shenzhen (CN)

(72) Inventors: Tiejun Mao, Shenzhen (CN); Zhiquan Wang, Shenzhen (CN); Xiaofu Luo, Shenzhen (CN)

(21) Appl. No.: 16/130,014

(22) Filed: Sep. 13, 2018

(30) Foreign Application Priority Data
Nov. 20, 2017 (CN) 201711160916.3
Nov. 20, 2017 (CN) 201721562939.2
Mar. 31, 2018 (CN) 201810286879.9

(51) Int. Cl. H01M 10/04; H01M 10/058; H01M 10/052

(52) U.S. Cl. CPC H01M 10/0404; H01M 10/052; H01M 10/058

(57) ABSTRACT

The invention discloses a lithium battery information fixture, which includes two relatively arranged supporting seats, a plurality of guide pillars arranged between the supporting seats, a compressing assembly arranged on the guide pillars, and a pushing mechanism arranged on the supporting seats driving the compression assemblies to slide along the guide pillars. A plurality of forming laminate assemblies are arranged between the two supporting seats, PCB board assemblies bonding to the electrode ears of the lithium batteries are arranged on the forming laminate assemblies, and adjusting laminates are arranged between the two supporting seats to adjust upper and lower position of the forming laminate assemblies and the PCB board assemblies. When the lithium batteries are placed between the adjacent laminates, the center position of the lithium batteries and the PCB board assemblies can be adjusted, thus realizing the formation of lithium batteries with different polar ear positions.

### FIELD OF SAID INVENTION

The present invention relates to battery formation fields, more specifically relates to a lithium battery formation fixture and an automation battery formation equipment.

### BACKGROUND OF SAID INVENTION

Formation is an essential process for lithium battery production. Chinese Utility Model patent: CN201620650281.X discloses a lithium battery formation fixture with adjustable force position, which discloses a fixture can adjust the position of the forming laminate so as to adjust the force point of the battery. In this patent, it is to manually rotate the adjusting screw to adjust the height of the adjustable guiding pillars, therefor adjusting the force point of the lithium battery, but this kind of formation equipment can only be applied to the formation of lithium batteries with the same polar ear positions. In order to meet the formation of lithium batteries with the different polar ear positions, it is need to replace the forming laminate. It will cause inconvenience to the formation of the battery and increase the cost of the formation. In addition, the present formation equipment requires the manipulators to clamp the battery to be formalized into the fixture one by one. After the completion of the battery formalization, the manipulator conveys the formalized batteries to the cold clamp for cooling, so it is difficult to satisfy the automatic production. In view of the above defects, it is necessary to design a lithium battery formation fixture and automation battery formation equipment.

### SUMMARY OF SAID INVENTION

The present invention provides a lithium battery formation fixture and an automation battery formation equipment to solve the problem that the current lithium battery formation equipment can not used for many different types of battery formation.

In order to solve the above technical problem, the technical proposals of the invention are as follows: a lithium battery formation fixture includes two opposite supporting seats, a plurality of guiding pillars arranged between the supporting seats and a compressing assembly arranged on the plurality of guiding pillars, a pushing mechanism is arranged on the supporting seats and drives the compressing assembly to slide along the guiding pillars; a plurality of forming laminate assemblies are arranged between the two supporting seats, PCB board assemblies bonding to the electrode ears of the lithium batteries are arranged on the forming laminate assemblies, and an adjusting mechanism is arranged between the two supporting seats to adjust upper and lower position of the forming laminate assemblies and the PCB board assemblies.

Further, the adjusting mechanism comprises: two adjusting assemblies, two connecting and sliding rails and two connecting and guiding rails. The two adjusting assemblies are respectively fixed to the inner sides of the two supporting seats. The adjusting assembly comprises a first adjusting plate, a first guiding rail, a fixed nut, a first wire rod, a first driving mechanism, two second guiding rails, a second adjusting plate, a movable nut, a second wire rod and a second driving mechanism. The first guiding rail is arranged at the inner side of the supporting seat and slid fits with the first adjusting plate. The fixed nut is arranged on the inner side of the supporting seat, and the first wire rod passes through the bottom of the first adjusting plate and the fixed nut in turn. The first wire rod is rotatably connected with the first adjusting plate and matched with the fixed nut; the two second guiding rails are arranged on both sides of the first adjusting plate, and the second adjusting plate is arranged on the two second guiding rails. The movable nut is fixed on the second adjusting plate, the second wire rod is matched with the moving nut and rotatably connected with the first adjusting plate. The first driving mechanism drives the first wire rod to rotate so that the first adjusting plate slides up and down along the first guiding rail, and the second driving mechanism drives the second wire rod to rotate so that the second adjusting plate slides up and down along the second guiding rail. The two ends of the two connecting and sliding rails are respectively fixed to both of the first adjusting plates. The two ends of the two connecting and guiding rails are respectively fixed to both of the second adjusting plates. The two sides of the upper ends of the forming laminate assemblies are respectively arranged on the two connecting and sliding rails. The PCB board assemblies on the forming laminate assemblies are arranged on the connecting and guiding rail.

The forming laminate assembly comprises a laminated plate, a connecting member arranged at both ends of the laminate plate, and a block arranged on the inner side of the laminated plate. When the pushing mechanism pushes the compressing assembly to press the plurality of laminate plates against the lithium batteries, the blocks compact the polar ears of the lithium batteries on the PCB board assemblies at the side of the adjacent forming laminate assemblies. The upper end of the connecting member is provided with a roller, and the lower end of the connecting member is provided with a guiding chute. The roller slides along the guiding chute on the top of the connecting and sliding rail. The PCB board assembly includes a slider mounted on the connecting and guiding rail and a PCB board fixed to the slider. The second driving mechanism drives the second adjusting plate to slide along the second guiding rail. The connecting and guiding rail pushes the slider to slide along the guiding chute. The laminate plate is also provided with a limiting step hole, and the PCB board is provided with a limiting pin running through the limiting step hole.

The inner side of the connecting and sliding rail is also provided with a support chute, and the outside of the connecting member is provided with a supporting roller extending into the supporting chute.

The the first adjusting plate also provided with a first hole and a second hole; the fixing nut is located in the first hole and the movable nut is located in the second hole; the lower end of the first wire rod is also covered with a connecting block, the connecting block is fixed at the bottom of the first adjusting plate; the upper end of the first wire rod is rotatably connected with the first adjusting plate and the lower end of the first wire rod is rotatably connected with the connecting block.

The first driving mechanism includes a first mounting seat arranged at the bottom end of the first adjusting plate, a first driving motor arranged on the first mounting seat, and a chain driving mechanism, a gear driving mechanism or a synchronous wheel driving mechanism arranged between the shaft of the first driving motor and the first wire rod; the second driving mechanism includes a second mounting seat arranged on the bottom end of the first adjusting plate, a second driving motor arranged on the second mounting seat, and a chain driving mechanism, a gear driving mechanism or a synchronous wheel driving mechanism arranged between the shaft of the second motor and the second wire rod.

The pushing mechanism includes four sets of wire rod pairs that are rotatably connected between the two supporting seats, servo motor driving mechanism which is arranged on one of the supporting seat and simultaneously drives four groups of the wire rod pairs to run. The other of the seat supporting seat is provided with a pressure sensor. The compressing assembly includes guiding sleeves sliding along the guide pillars, a pushing plate connected with the guiding sleeves, a driving and mounting assembly tightly coupled with the nuts of the wire rod pairs, and a pressurized cylinder arranged on the driving and mounting assembly. The pressurized cylinder is connected with the air pressure adjusting laminate by pipeline; the piston rod of the pressurized cylinder runs through the driving and mounting assembly; the servo motor driving mechanism drives the wire rod pairs to run so that the compressing assembly pushes the adjacent laminate assemblies to press the lithium batteries, and the pressurized cylinder pushes the pushing plate to slide and compact the batteries along the guiding pillars.

The present invention also discloses an automation battery formation equipment with the lithium battery formation fixture, which includes a battery clamping mechanism and a base. The base is provided with a conveying line for conveying the material carrier, a feeding and positioning mechanism for storing and locating the batteries before formation, a unloading storage mechanism for the battery temporarily stored after the formation, a crossbeam frame, a cold pressing fixture and a loading and unloading manipulator. The loading and unloading manipulator is arranged above the conveying line. The crossbeam frame is provided with an opening clamp mechanism. The feeding and positioning mechanism, the unloading storage mechanism, the lithium battery formation fixture and the cold pressing fixture are arranged along the moving direction of the opening clamp mechanism. The conveying line conveys the material carrier which contains batteries to be formed to the lower part of the loading and unloading manipulator. The loading and unloading manipulator transfers the batteries on the material carrier into the feeding and positioning mechanism. The opening clamp mechanism clamps and opens the battery clamping mechanism, which clamps the batteries positioned in the feeding and positioning mechanism into the lithium battery formation fixture.

Both of the feeding and positioning mechanism and the unloading storage mechanism are chain-type conveying and positioning mechanisms. The chain-type conveying and positioning mechanism includes two mounting plates arranged opposite to the base, two rotating shafts arranged between the two mounting plates, two sprocket chain conveyors arranged between the two rotating shafts, a second driving mechanism arranged on the mounting plates and driving the sprocket chain conveyors to run, a plurality of connecting plates arranged between the chains of the two sprocket chain conveyors and a positioning assembly arranged on the connecting plate.

The crossbeam frame includes two supporting frames arranged in parallel at the top of the base, two beams connected between the two supporting frames. The two beams are respectively connected at two ends between the two supporting frames.

The battery clamping mechanism includes a frame, a clamping mechanism, a limiting pin, a limiting mechanism and a chain. The number of clamping mechanisms is plurality, distributed within the framework. The clamping framework at the front of the frame is fixed to the frame. The clamping framework, one side of which is provided with a limiting mechanism, arranged at the end of the frame are active fixed to the frame. The limiting pin is located on the top surface at the end of the frame, a plurality of of the clamping mechanisms are pivotally connected with the chain. The chain pulls the clamping mechanism to slide within the frame.

The opening clamp mechanism comprises a mobile frame and a lifting mechanism provided on the mobile frame. The lifting mechanism drives a second mounting plate which is located at the bottom end of the mobile frame to move up and down. The bottom end of the second mounting plate is provided with a clamping mechanism. The clamping mechanism comprises a mounting block arranged at the bottom end of the second mounting plate, the two sides of the mounting block are respectively provided with a retractor assembly. The bottom end of the mounting block is provided with a driving mechanism that pushes the two retractor assemblies to swing to the two sides respectively. The bottom end of the mounting block is also provided with a pushing and pressing mechanism which pushes the clamping mechanism to open. The two ends of the mobile rack are respectively located at the top of the two supporting frames.

The top face of the supporting frame is arranged parallel with the guiding rail and the rack. The mobile frame includes a moving seat, a sliding block is set at the bottom of the moving seat ends and connected with the guiding rail. A plurality of housing seats are arranged on the top of the moving seat, and a rotary shaft passes through the bearing of the plurality of bearing seats. Both ends of the rotary shaft are provided with a gear, and the two gears are engaged with the rack on the two supporting frames, respectively. A deceleration motor assembly arranged on the moving seat drives the rotary shaft to rotate.

The cold pressing fixture includes two opposite sets of the second mounting seats, four sets of second guiding rods arranged between the two second mounting seats, a plurality of groups of cold pressed laminates and a second compressing assembly arranged on four groups of second guiding rods, a second pushing mechanism arranged on the second mounting seat. The second pushing mechanism drives the second compressing assembly to slide along the second guiding rods so that the batteries are pressed between the adjacent two cold pressed laminates. The cold pressed laminate is provided with a circulating water circuit connected with the water cooling system.

The conveying line includes a first chain conveyor and a second chain conveyor arranged parallel up and down, and a lifting conveyor connecting the first chain conveyor and the second chain conveyor. A pneumatic positioning assembly is arranged at the end of the first chain conveyor.

The loading and unloading manipulator. is a six-axis manipulator. The top of the base is also provided with a positioning and supporting seat for placing the battery clamping mechanism. The feeding and positioning mechanism, the positioning and supporting seat, the unloading storage mechanism, three groups of the lithium battery forming equipment and one group of the cold pressing fixture are arranged in turn along the moving direction of the opening clamp mechanism on the crossbeam frame. The feeding and positioning mechanism and the unloading storage mechanism are located on one side of the conveying line.

Compared with the prior art, the lithium battery formation fixture and the automatic formation equipment in the present invention have the following beneficial effects:

A plurality of forming laminate assembly are arranged between the two supporting seats, PCB board assemblies bonding to the electrode ears of the lithium batteries are arranged on the forming laminate assemblies, and the adjusting mechanism is arranged between the two supporting seats to adjust upper and lower position of the forming laminate assemblies and the PCB board assemblies. When the lithium batteries are placed between the adjacent forming laminate assemblies, the center positions of the lithium batteries and the position of the PCB board assemblies can be adjusted by the adjusting mechanism, thus it can realize the formation of many kinds of lithium batteries with different polar ear positions. Therefore, when the lithium battery formation fixture is used for different lithium batteries formation, it is not necessary to replace the forming laminate assemblies and the PCB board assemblies, thus increasing the formation efficiency and reducing the cost.

The automatic formation equipment with the above lithium battery formation fixture can transport the material carrier filled with batteries to the formation equipment through the conveying line. The loading and unloading manipulator clamps the batteries in the material carrier and transports to the feeding and positioning mechanism, then the opening clamp mechanism clamps and opens the battery clamping mechanism, which clamps the batteries positioned on the feeding and positioning mechanism and transports the the batteries into the lithium battery formation fixture. After formation, the opening clamp mechanism drives the battery clamping mechanism clamped the formed battery to move into the cold pressing fixture for cold-pressure, after the cold-pressing process, the batteries are placed on the unloading storage mechanism. It realizes automatic formation and increase battery productivity.

### BRIEF DESCRIPTION OF SAID DRAWINGS

FIG. 1 is a perspective of the lithium battery formation fixture in the present invention.

FIG. 2 is a main view of the lithium battery formation fixture in the invention.

FIG. 3 is an internal structure diagram of the lithium battery formation fixture in the invention.

FIG. 4a is a structure diagram of the laminated plate of the lithium battery formation fixture in the invention; FIG. 4b is a reverse structure diagram of the laminated plate of the lithium battery formation fixture in the invention.

FIG. 5a is a structure diagram of the two polar ears of the lithium battery B arranged at the same side fit with the two independent circuits 151a and 151b of the PCB board 151 arranged on one side of the laminated plate 140; FIG. 5b is a structure diagram of the two polar ears of the lithium battery B arranged at the different side fit with the two PCB boards arranged on both sides of the laminated plate 140.

FIG. 6 is a perspective diagram of the adjusting laminate of the lithium battery formation fixture in the present invention.

FIG. 7 is a perspective diagram of the portion of the adjusting laminate of the lithium battery formation fixture in the present invention.

FIG. 8 is a local amplification view of the adjusting laminate of the lithium battery formation fixture in the present invention.

FIG. 9 is a structure diagram of the compaction assembly of the lithium battery formation fixture in the present invention.

FIG. 10 is a sectional view of the guiding sleeve portion of the lithium battery formation fixture in the present invention.

FIG. 11 is a structure diagram of the servo motor driving mechanism part of the lithium battery formation fixture in the present invention.

FIG. 12 is a structure diagram of the automation formation equipment in the present invention.

FIG. 13 is a main view of the automation formation equipment in the present invention.

FIG. 14 is a structural diagram of the chain conveyor positioning mechanism of the automation formation equipment in the invention.

FIG. 15 is a bottom structure diagram of the chain type conveying positioning mechanism of automation formation equipment in the present invention.

FIG. 16 is a structural diagram of the connecting board portion of the automation formation equipment in the present invention.

FIG. 17 is a structural diagram of the crossbeam frame of the automation formation equipment in the invention.

FIG. 18 is a structural diagram of the battery clamping mechanism of the automation formation equipment in the present invention.

FIG. 19 is a main view of the holding mechanism of the automation formation equipment in the present invention.

FIG. 20 is an internal structure diagram of the clamping mechanism of the automation formation equipment in the present invention.

FIG. 21 is a structural diagram of the clamping limit structure of the automation formation equipment in the present invention.

FIG. 22 is a top-down view of the clamped limit structure of the automation formation equipment in the present invention.

FIG. 23 is a sectional view diagram of the clamped limit structure of the automation formation equipment in the present invention.

FIG. 24 is a structural diagram of the opening clamping mechanism of the of the automation formation equipment in the present invention.

FIG. 25 is an internal structure diagram of the open clamping mechanism of the of the automation formation equipment in the present invention.

FIG. 26 is the main view of the traveling frame clamping mechanism of the automation formation equipment in the present invention.

FIG. 27 is a structural diagram of the opening mechanism of the automation formation equipment in the present invention.

FIG. 28 is a main view of the automation formation equipment in the present invention.

FIG. 29 is a local magnifying view of the automation formation equipment in the present invention.

FIG. 30 is a main view of the lifting mechanism of the automation formation equipment in the present invention.

FIG. 31 is a perspective of the cold pressing fixture of the automation formation equipment in the present invention.

FIG. 32 is an internal structure diagram of the cold pressing fixture of the automation formation equipment in the present invention.

FIG. 33 is a structural diagram of the conveying mechanism portion of the automation formation equipment in the present invention.

FIG. 34 is a structural diagram of the first chain conveyor of the automation formation equipment in the present invention.

FIG. 35 is a perspective of the lifting and conveying mechanism of the automation formation equipment in the present invention.

### EMBODIMENTS

The following specific embodiments will be further explained in conjunction with the above drawings.

A variety of specific details are described below to provide a thorough understanding of the concepts that form the basis of the described embodiments. However for those skilled in the art it is clear that the described embodiments can be implemented without some or all of these particular details. In other cases, there is no specific description of the well-known processing steps.

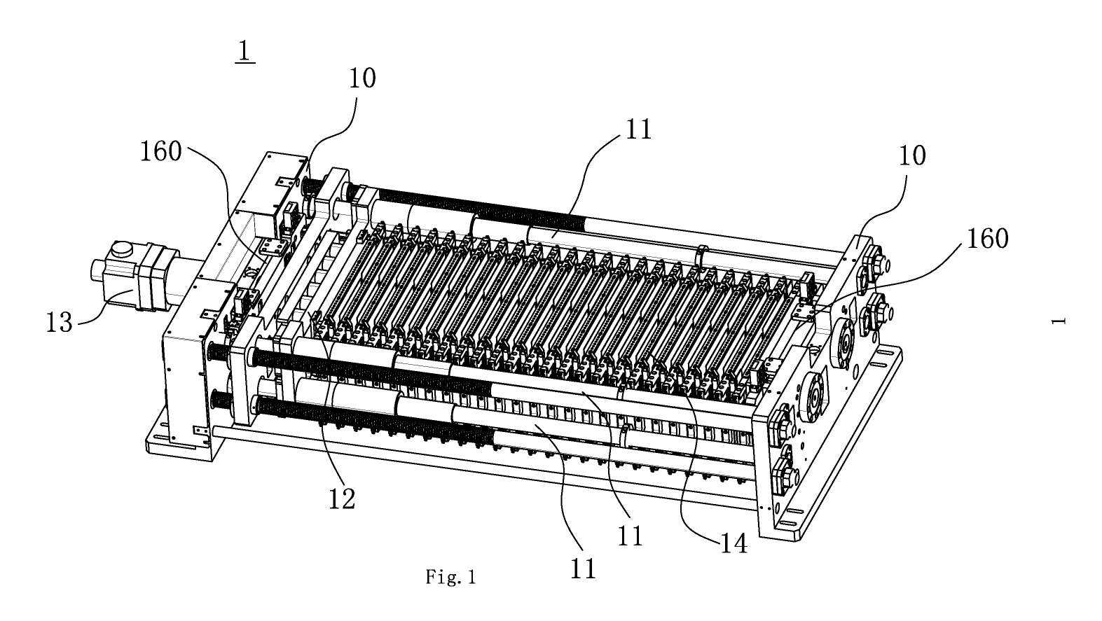

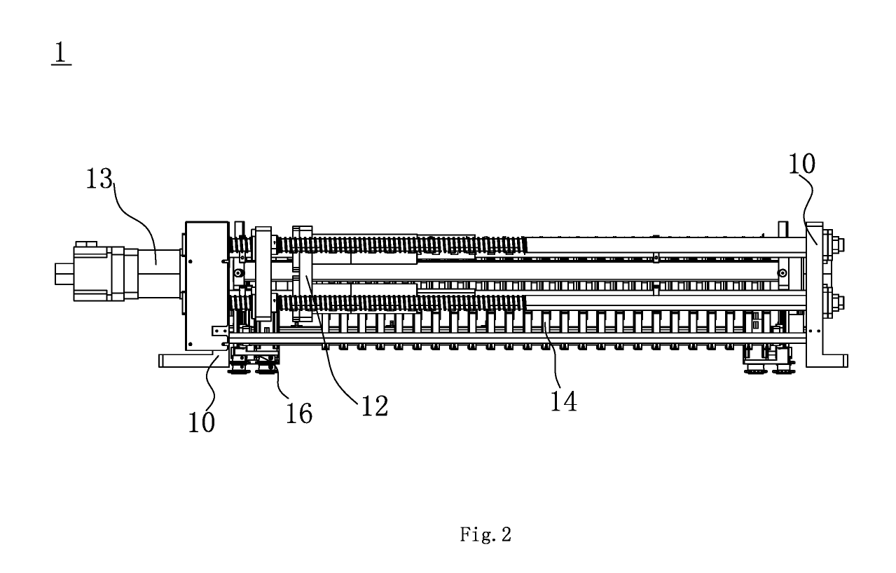

As shown in FIG. 1-5, the lithium battery formation fixture 1 comprises two opposite supporting seats 10, a plurality of guide pillars 11 are arranged between the two supporting seats 10. A plurality of of the guide pillars 11 are yoked with a compressing assembly 12. A pushing mechanism 13, arranged on the the two supporting seats 10, drives the compressing assembly 12 to slide along the guide pillars 11. A plurality of forming laminate assemblies 14 are arranged between the two supporting seats 10. Each of the forming laminate assembly 14 is provided with a PCB board assembly 15 bonding to the electrode ear of the lithium battery and electrically connecting with power supply. Concretely, when it is formed, a “V” shaped mesh pocket or a “V” mailla is arranged at the lower ends between the adjacent forming laminate assemblies 14 to support the lithium batteries. The lithium battery is arranged between the adjacent forming laminate assemblies 14, and then the pushing mechanism 13 drives the compressing assembly 12 to slide along the guide pillars 11, so that the forming laminate assemblies 14 compact the batteries, the batteries can be electrified and formed. A adjusting mechanism 16 is arranged between the two supporting seats to adjust the positions of the forming laminate assemblies 14 for changing the center positions of the lithium batteries, the adjusting mechanism 16 can also adjust the upper and lower positions of the PCB board assemblies 15. Therefore, when the lithium battery formation fixture 1 used for the formation of a variety of lithium batteries with different polar ear positions, it is no need to replace the forming laminate assemblies 14 and the PCB board assemblies 15, thus it increasing the formation efficiency and reducing the cost.

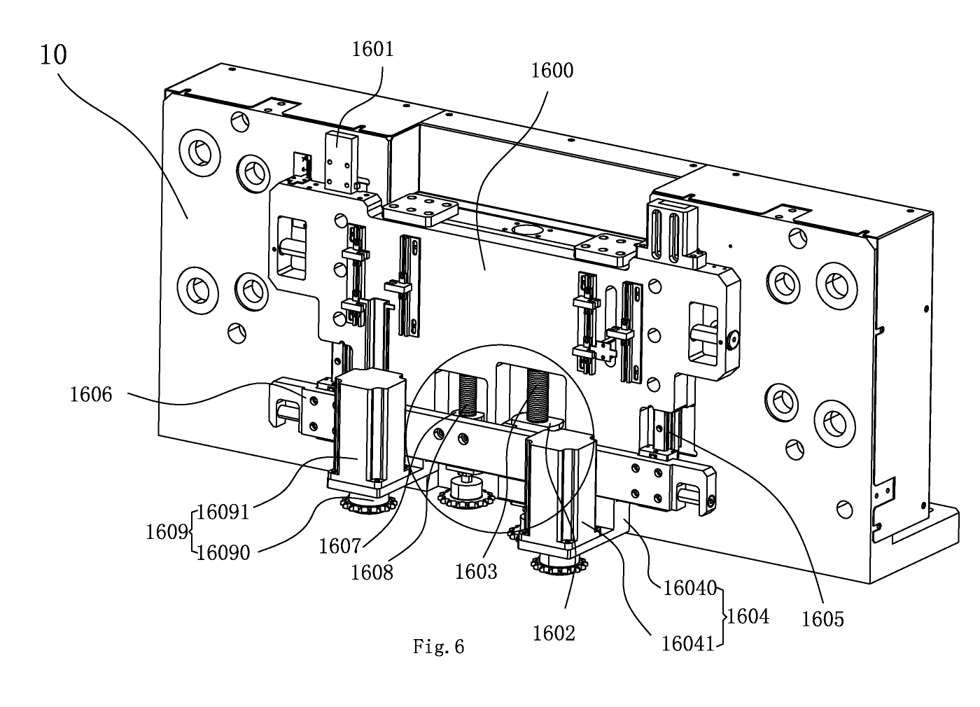

As shown in FIG. 6-8, the adjusting mechanism 16 comprises two adjusting assemblies 160 respectively fixed to the inner side of the two supporting seats 10, two connecting and sliding rails 161 and two connecting and guiding rails 162. The adjusting assembly 160 comprises a first adjusting plate 1600, a first guiding rail 1601, a fixed nut 1602, a first wire rod 1603, a first driving mechanism 1604, two second guiding rails 1605, a second adjusting plate 1606, a movable nut 1607, a second wire rod 1608 and a second driving mechanism 1609. The first guiding rail 1601 is fixed at the inner side of the supporting seat 10 and slip fits to the first adjusting plate 1600. The fixed nut 1602 is arranged on the inner side of the supporting seat 10. The first wire rod 1603 passes through the bottom end of the first adjusting plate 1600 and the fixed nut 1602 in turn, and the first wire rod 1603 is rotatably connected with the first adjusting plate 1600 and fitted with the fixed nut 1602 by thread. Two pieces of the second guiding rails 1605 are arranged on both sides of the first adjusting plate 1600 respectively, with the same direction of the first guiding rail 1601, the second adjusting plate 1606 is arranged on the two second guiding rails 1605, and the moving nut 1607 is fixed to the second adjusting plate 1606. The second wire rod 1608 is matched with the movable nut 1607 by thread and rotatably connected with the first adjusting plate 1600. The first driving mechanism 1604 drives the first wire rod 1603 to rotate so that the first adjusting plate 1600 slides up and down along the first guiding rail 1601 to adjust the position of the first adjusting plate 1600. The second driving mechanism 1609 drives the second wire rod 1608 to rotate so that the second adjusting plate 1606 slides up and down along the second guide 1605 to adjust the position of the second adjusting plate 1606. The two ends of the two connecting and sliding rails 161 are respectively fixed to the two first adjusting plates 1600; the two ends of the two connecting and guiding rails 162 are respectively connected to the two second adjusting plates 1606. The two sides of the upper end of the formation laminate assembly 14 are respectively arranged on the two connection slide rail 161; the PCB board assembly 15 on the formation laminate assembly 14 are respectively yoked on the connection guiding rail 162. Therefore, it can adjust the position of the first adjusting plate 1600 to change the position of the adjusting laminate assembly 14; it also can adjust the position of the second adjusting plate 1606 to adjust the position of the PCB board assembly 15.

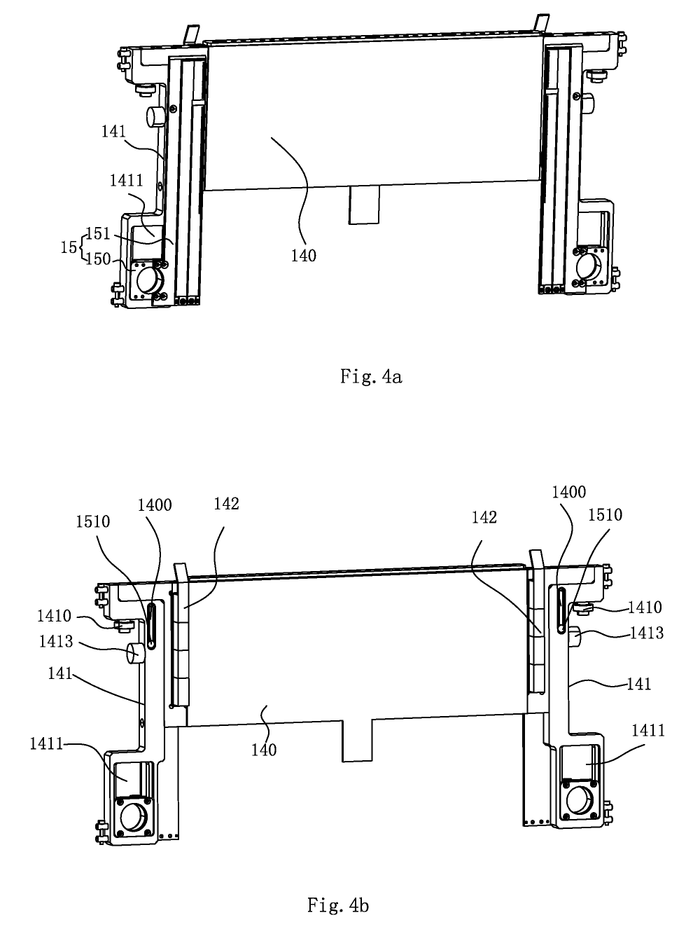

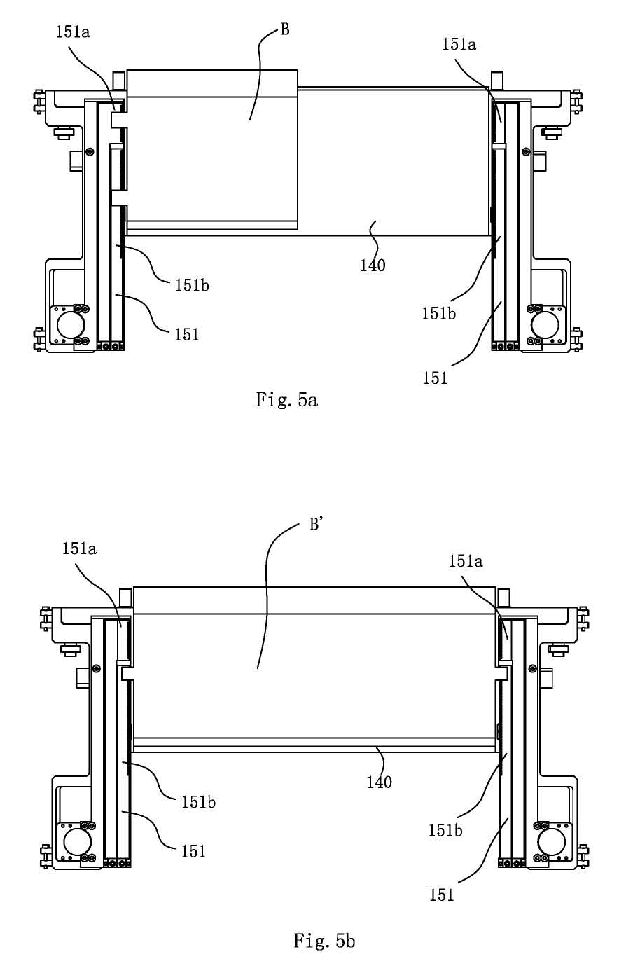

As shown in FIG. 4a-5b, the forming laminate assembly 14 comprises a laminate 140, two connecting members 141 at both ends of the laminate 140, and two blocks 142 arranged on the inner sides of the laminate 140. When the pushing mechanism 13 pushes the compressing assembly 12, the plurality of laminates 140 tpress the lithium batteries, the blocks 142 compact the electrode ears of the lithium batteries on the PCB board assemblies 15 on the sides of the adjacent plurality of forming laminate assemblies 14. The upper end of the connecting member 141 is provided with a roller 1410, and the lower end of the connecting member 141 is provided with a guiding chute 1411. The top the the connecting and sliding rail 161 is arranged with slide groove. The roller 1410 slides along the slide groove at the top of the connecting and sliding rail 161. The PCB board assembly 15 includes a slider 150 mounted on the connecting guide 162 and a PCB board 151 which is fixed to the slider 150. When the second driving mechanism 1609 drives the second adjusting plate 1606 to slide along the second guiding rails 1605, the connecting and guiding rail 162 pushes the slider 150 to slide along the guiding chute 1411. The laminated plate 140 is also provided with a limiting step hole 1400, and the PCB board 151 is provided with a limiting pin 1510 through the limiting step hole 1400. Therefore, the limiting step hole 1400 has the function of limiting and sliding guide the PCB board 151.

In particular, referring to FIG. 5a, the PCB board 151 is provided with two independent circuit, 151a and 151b, which can be electrically connected to positive and negative electrodes of the forming power supply, respectively. Both sides of the laminated plate 140 are provided with a PCB board 151. When the two polar ears of the lithium battery B to be formed are arranged at the same side of it, the two polar ears fit with the two independent circuits 151a and 151b of the PCB board 151 respectively, the two independent circuits 151a and 151b of the PCB board 151 are electrically connects to positive and negative electrodes of the forming power supply, respectively. Referring to FIG. 5b, when the two polar ears of the lithium battery B′ to be formed are arranged at the different side of it, the two polar ears fit with the two PCB board 151 respectively, the PCB board 151 are electrically connected to positive and negative electrodes of the forming power supply, respectively. Thus it increases the versatility of the equipment.

Further, the adjacent laminates 140 are provided with equidistant flexible connectors (not shown in the drawings); the flexible connectors are chains, ropes, etc. When the formation fixture 1 is opened, the flexible connectors promise the equal distance between the laminates 140, so that it is convenient for picking up the battery together by the manipulator.

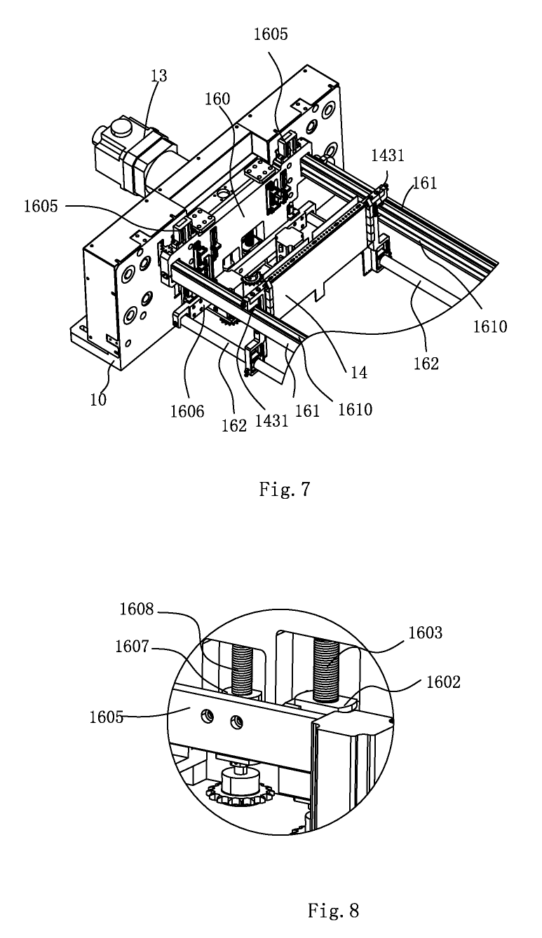

Further, referring to FIG. 7, the top side of the connecting and sliding rail 161 is also provided with a support chute 1610, and the bottom side of the connecting member 141 is provided with a supporting roller 1413 extending into the supporting chute 1610, the support roller 1413 can be limiting within the supporting chute 1610, therefor the connecting and sliding rail 161 can support and guide the laminate 140.

Further, referring to FIGS. 6 and 8, the first adjusting plate 160 is also provided with a first hole and a second hole; the fixing nut 1602 is located in the first hole and the movable nut 1607 is located in the second hole. The lower end of the first wire rod 1603 is also covered with a connecting block, the connecting block is fixed at the bottom of the first adjusting plate 1600. The upper end of the first wire rod 1603 is rotatably connected with the first adjusting plate 1600 and the lower end of the first wire rod 1603 is rotatably connected with the connecting block. Therefore, the first driving mechanism 1604 drives the first wire rod 1603 to rotate, with the cooperation of the fixed nut 1602, the first wire rod 1603 can move up and down, so that the first adjusting plate 1600 is driven up and down under the action of the connecting block. The upper and lower ends of the second wire rod 1608 are rotatably connected to the first adjusting plate 1600.

Further referring to FIGS. 6 and 8, both of the first driving mechanism 1604 and the second driving mechanism 1609 include motor, sprocket and chain driving mechanisms. Concretely, the first driving mechanism 1604 includes a first mounting seat arranged at the bottom end of the first adjusting plate 1600, a first driving motor 16041 arranged on a first mounting seat, and a chain driving mechanism, a gear driving mechanism, or a synchronous wheel driving mechanism arranged between the shaft of the first driving motor 16041 and the first wire rod 1603. The second driving mechanism 1609 includes a second mounting seat arranged on the bottom end of the first adjusting plate 1600, a second driving motor 16091 arranged on the second mounting seat, and a chain driving mechanism, a gear driving mechanism, or a synchronous wheel driving mechanism arranged between the shaft of the second motor 16091 and the second wire rod.

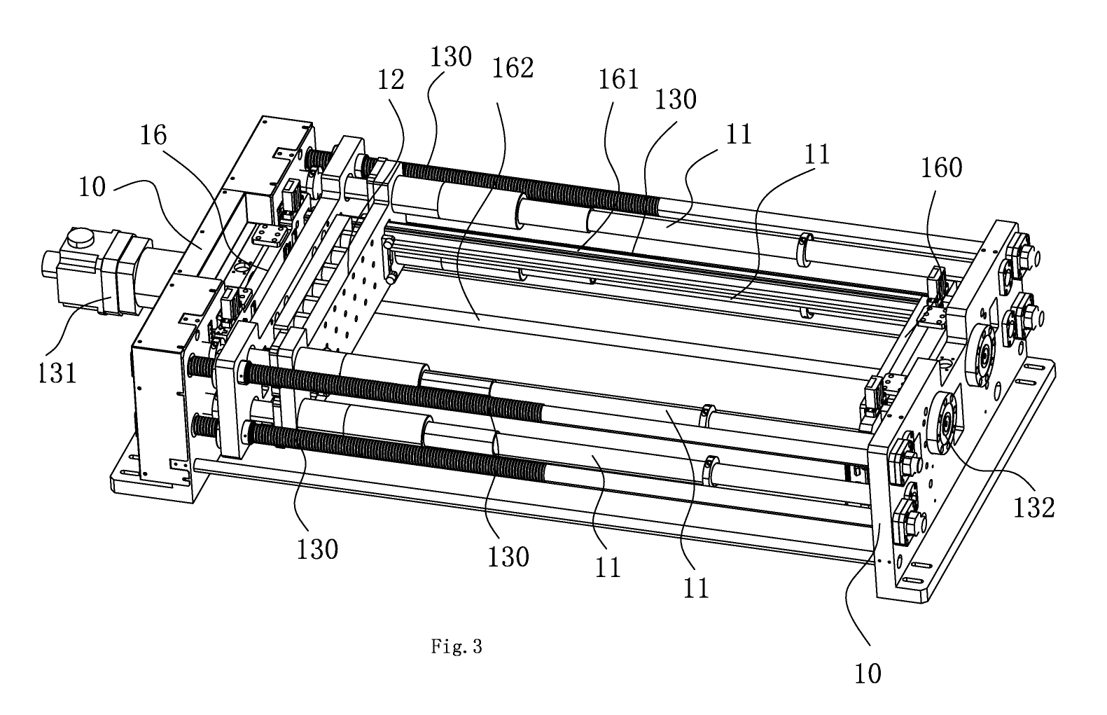

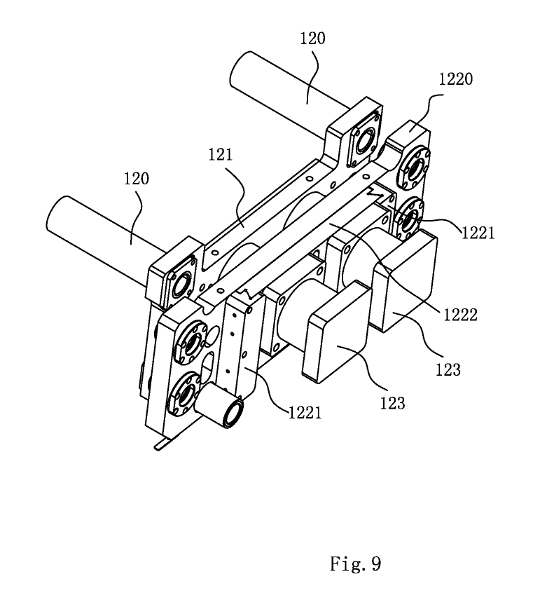

Further referring to FIG. 3 and FIG. 9, there are four guide pillars 11 symmetrically arranged in four diagonal positions between the two supporting seats 10. The pushing mechanism 13 includes four groups of wire rod pairs 130 rotatably connected between the two supporting seats 10, a servo motor driving mechanism 131 arranged on one of the supporting seat 10 and simultaneously driving the four groups of the wire rod pairs 130 to run and a pressure sensor 132 arranged on the other supporting seat 10. The compressing assembly 12 includes guiding sleeves 120 sliding along the guide pillars 11, a pushing plate 121 connecting a plurality of the guiding sleeves 120, and a driving and installing assembly tightly coupled with the nut of the wire rod pair 130 and a pressurized cylinder 123 arranged on the driving and installing assembly. Concretely the driving and installing assembly includes a driving plate 1220, two limiting plates 1221 symmetrically arranged on two sides of the driving plate 1220 and an adjusting plate 1222 arranged between the two limiting plates 1221. The driving plate 1220 is connected with the nut of the wire rod pair 130. The inner side of the limiting plate 1221 is provided with a limiting slot. The two limiting slots form an installation chute. The adjusting plate 1222 is arranged in the installation chute. The side of the limiting plate 1221 is provided with a locking mechanism for locking the adjusting plate 1222 (unmarked in the drawings). The locking mechanism is a locking screw arranged on one side of the limiting plate 1221. The limiting plate 1221 is provided with a threaded through hole to fit the locking screw. The pressurized cylinder 123 is arranged on the outer side of the adjusting plate 1222, the piston rod of the pressurized cylinder 123 runs through the adjusting plate 1222 and the driving plate 1220, and the driving plate 122 is provided with a slot for the hollow piston rod. The force center of the pressurized cylinder 123 is adjusted by the plate adjusting 1222 so that it is ensured that the compression force of the pressurized cylinder 123 is located in the center position of the power battery. The pressurized cylinder 123 is connected with the air pressure adjusting mechanism by pipeline. The piston rod of the pressurized cylinder 123 runs through the driving and installing assembly. The servo motor driving mechanism 131 drives the wire rod pair 130 to run so that the compressing assembly 12 drives the adjacent forming laminar assemblies 14 to press the lithium battery, and the pressurized cylinder 123 pushes the pushing plate 121 sliding along the guide column 11 to press the battery. Concretely, the air pressure adjusting mechanism may be an electric pressure regulator and an electrical proportional valve; the pressure applied to the compressed battery is regulated by the electric pressure regulator or the electrical proportional valve by the pressurized cylinder 123. When the power battery is compressed, the pressurized cylinder 123 may push the pushing plate 121 to move along the guide pillars 11, the pushing plate 121 push the pressing assembly 12, thereby clamping the battery. At the time of formation, the power battery to be formed is arranged between the adjacent formation laminar assemblies 14, the servo motor driving mechanism 131 drives the wire rod pairs 130 to run, so that the pushing mechanism 13 drives the compressing assembly 12 to slide along the guide pillars 121 and compress the lithium batteries, and the pressurized cylinder 123 pushes the pushing plate 121 to slide along the guide pillars 121 to compress the batteries. The electrodes of the batteries are connected to the forming circuit. During the process of formation, the batteries are inflated and pressurized, so the pressure sensor 132 detects the pressure on the batteries. Optionally, the pressure sensor 132 and the air pressure adjusting mechanism are docked with the PLC control system. The pressure sensed by the pressure sensor 132 is transmitted to the PLC control system, and the PLC control system controls the electric pressure regulating valve or the electric proportional valve to adjust the pressure in the pressurized cylinder 123, thus the pressure of the batteries is adjusted. Therefore, it is not necessary to adjust the position of the pushing mechanism 13 to adjust the battery pressure through the wire rod pair 130, thereby achieving the protective effect on the wire rod pair 130.

Referring to FIG. 10, the guiding sleeve 120 includes two ball bushing 1200 and a limiting block 1201, two extrusion springs 1202 arranged on the outside of the two ball bushing 1200 respectively, and a guiding sleeve 1203 sliding along the two ball bushing 1200. The pushing plate 121 is connected with the guiding sleeve 1203; the end portions of the two extrusion spring 1202 are respectively limited on the ball bushing 1200 and the limiting block 1201. Under the action of extruding spring 1202, the two ball bushing 1200 can always be connected, so that the guiding sleeve 1203 can always slide on the two ball bushing 1200.

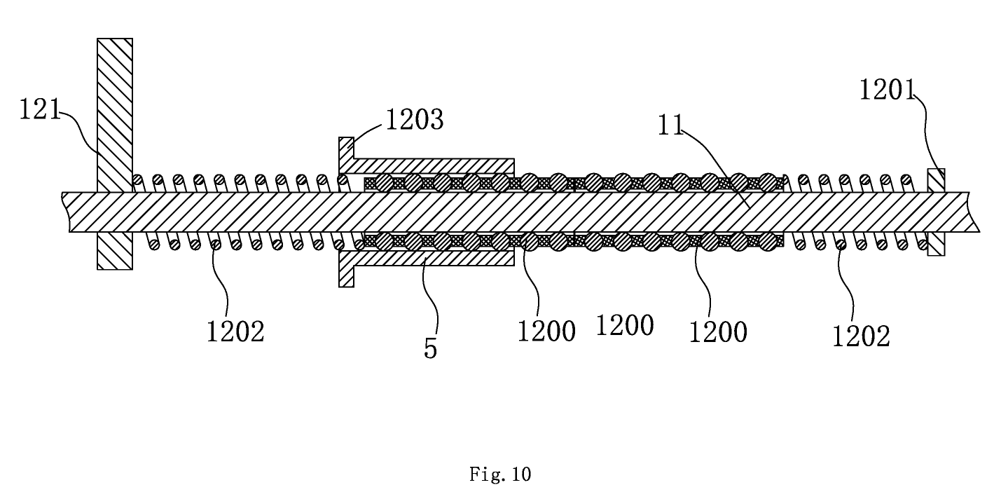

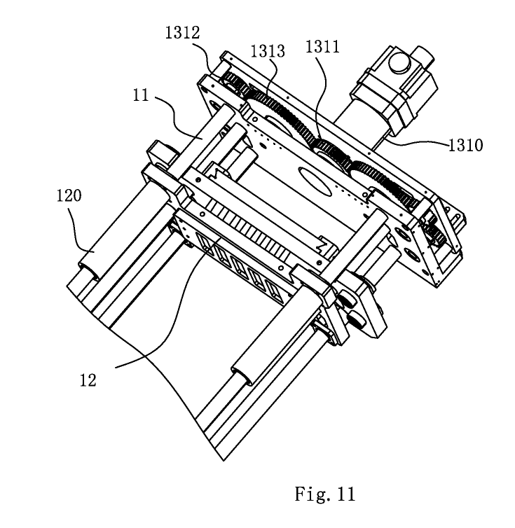

Referring to FIG. 11, the servo motor driving mechanism 131 includes a motor 1310 arranged on one side of the supporting seat 10, a driving gear 1311 mounted on the main shaft of the motor 1310, four driven gears 1312 mounted on the end of each of the four wire rod pairs 130, and two transition gears 1313 arranged between the driving gear 1311 and the driven gear 1312. The driving gear 1311 and two of the driven gears 1312 are engaged with one of the transition gears 1313. Under the action of motor 1310, the driving gear 1311 drives the two transition gears 1310 which are located on both sides of it to rotate, and then the two transition gears 1310 drives the four driven gear 1312 to rotate, thereby driving 4 sets of wire rod pairs 130 to rotate simultaneously in the same direction. The main shaft of the motor 1310 is extended into the supporting seat 10, all of the driving gear 1311, the four driven gear 1312 and the two transition gears 1313 are arranged within the supporting seat 10, and the transition gear 1313 is rotatably connected to the supporting seat 10. Further, a plurality of supporting columns are arranged on the outside of the supporting seat 10, a plurality of supporting columns are connected with one side plate, and the motor 1310 is arranged at the outside the side plate and the main shaft runs through the side plate.

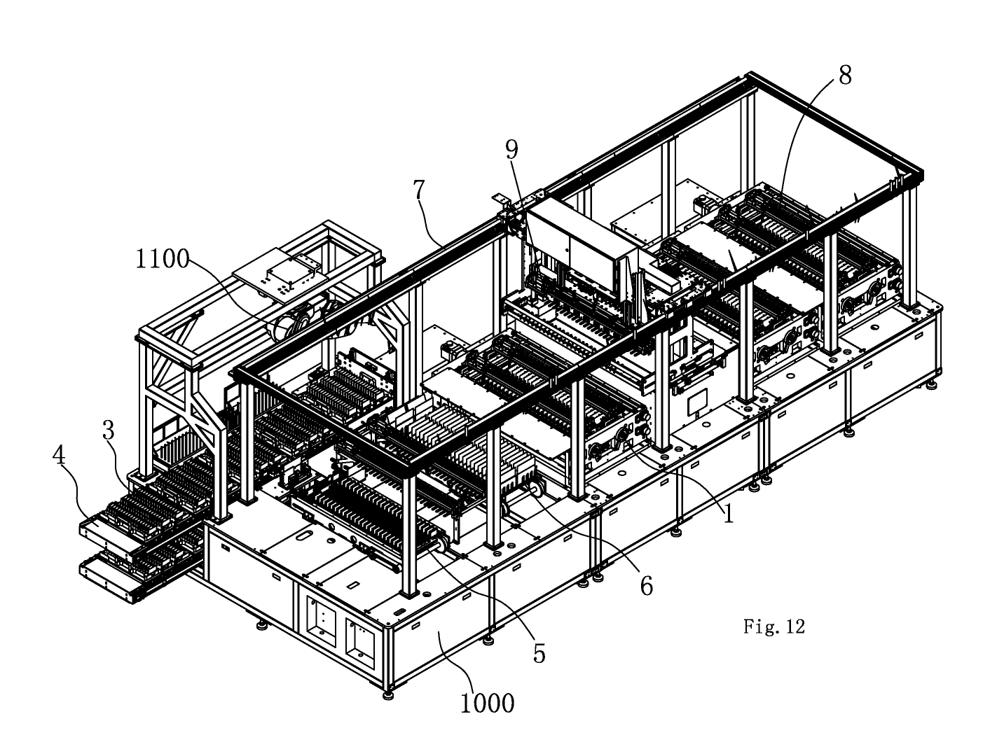

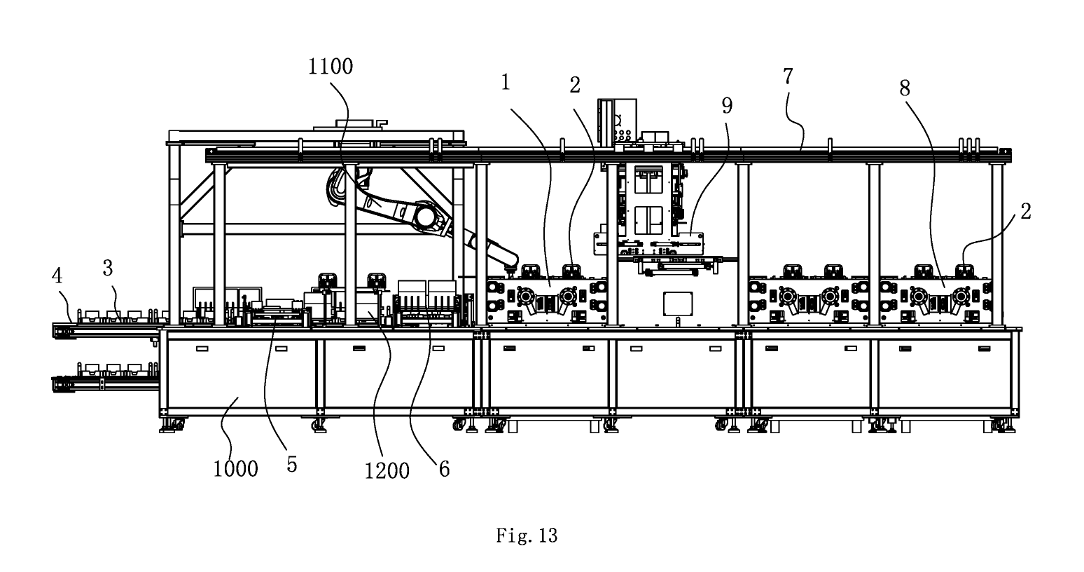

Referring to FIGS. 12 and 13, the present invention also discloses an automation battery formation equipment with the lithium battery formation fixture 1, which includes battery clamping mechanism 2 and base 1000. The base 1000 is provided with a conveying line 4 for a conveying material carrier 3, a feeding and positioning mechanism 5 for storing and locating the batteries before formation, a unloading storage mechanism 6 for the batteries temporarily stored after the formation, a crossbeam frame 7, a cold pressing fixture 8 and a loading and unloading manipulator 1100. The loading and unloading manipulator 1100 is arranged above the conveying line 4. Concretely, a mounting frame 1300 is arranged on the base 1000, and the loading and unloading manipulator 1100 is fixed to the mounting frame 1300. The crossbeam frame 7 is provided with an opening clamp mechanism 9, which can move along the crossbeam frame 7. The feeding and positioning mechanism 5, the unloading storage mechanism 6, the lithium battery formation fixture 1 and the cold pressing fixture 8 are arranged along the moving direction of the opening clamp mechanism 9. The conveying line 4 conveys the material carrier 3 which contains batteries to be formed to the lower part of the loading and unloading manipulator 1100. The loading and unloading manipulator 1100 transfers the batteries on the material carrier 3 into the feeding and positioning mechanism 5. The opening clamp mechanism 9 clamps and opens the battery clamping mechanism 2, which clamps and the batteries positioned in the feeding and positioning mechanism 5 into the lithium battery formation fixture 1. Further, a sealing cover is provided on the base 1000. The lithium-battery formation fixture 1, the feeding and positioning mechanism 5, the unloading storage mechanism 6, the crossbeam frame 7, the cold pressing fixture 8 and the opening clamp mechanism 9 are all arranged in the sealing cover. And there is a feed inlet on the side of the seal cover. The feeding end and exiting ends of the conveying line 4 extend to the outside of the feed inlet. After formation, the opening clamp mechanism 9 drives the battery clamping mechanism 2 clamping the formed battery to move together into the cold pressing fixture 8 for realizing the cold pressing treatment of the batteries, then, the batteries are placed on the unloading storage mechanism 6. All of the process realizes automate formation and increases the production efficiency.

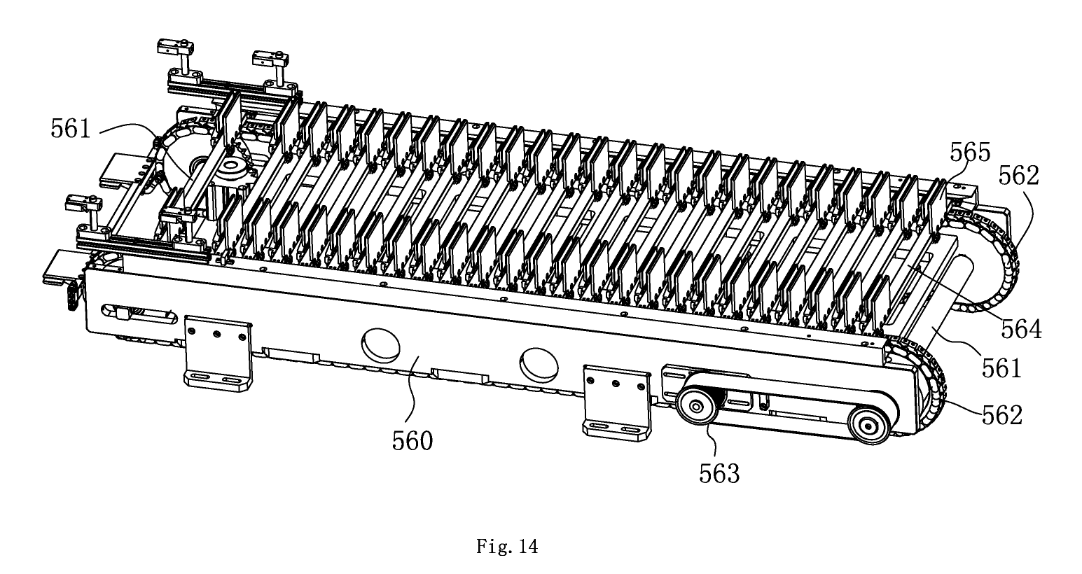

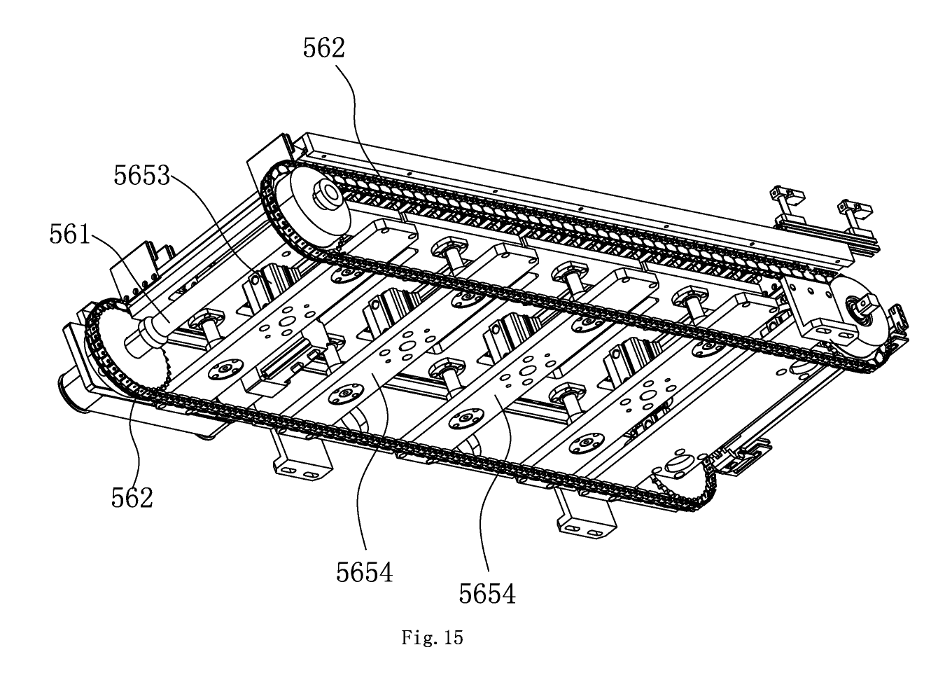

Referring to FIGS. 14 and 15, both of the feeding and positioning mechanism 5 and the unloading storage mechanism 6 are chain-type conveying and positioning mechanisms, which comprises two mounting plates 560 arranged opposite to the base 1000, two rotating shafts 561 arranged between the two mounting plates 560, two sprocket chain conveyors 562 arranged between the two rotating shafts 561, and a third driving mechanism 563 arranged on the mounting plates 560 and driving the two sprocket chain conveyors 562 to run, a plurality of connecting plates 564 arranged between the two sprocket chain conveyors 562, and a positioning assembly 565 arranged on the connecting plate 564. Further, the two sprocket chain conveyors 562 are located between the two mounting plates 560. Specifically, the sprocket chain conveyor 562 includes two sprockets tightly attached to the two ends of the rotating shaft 561 and a chain wrapped around the two sprockets respectively. The two ends of the connecting plate 564 are respectively connected on the two chains, and the adjacent connecting plates 564 are parallel to each other. When the third driving mechanism 563 drives one of the rotating shaft 561 to rotate, the chain drives the connecting plate 564 to move together. Specifically, the side of the chain is also provided with an connecting part extending outward, the end part of the connecting plate 564 is fastened to the connecting part by screws.

Further, the third driving mechanism 563 includes a servo motor arranged on the inner side of a mounting plate 560 and a synchronous belt wheel driving mechanism arranged between the servo motor and the rotary shaft 561. The servo motor drives the rotating shaft 561 through the synchronous belt wheel driving mechanism, thus driving the two sprocket chain conveyors 562 to rotate.

Further, the positioning assembly 565 includes a splint assembly arranged at both ends of the connecting plate 564. The splint assembly is two limiting plates arranged opposite on both sides of the connecting plate 564. The loading and unloading manipulator 1100 holds the batteries on the conveying line 4 and places them between the two limiting plates, therefore positioning the batteries. Furthermore, when the loading and unloading manipulator 1100 places the batteries on the positioning assembly 565, the second driving mechanism 563 drives the sprocket chain conveyors 562 to the next working station, and the next positioning assembly 565 moves to the clamping position.

Further, the inner sides of the two mounting plates 560 are provided with guiding chutes, and the orifice of the guiding chute is provided with a guide angle. When the sprocket chain conveyors 562 drive the connecting plate 564 to move from the bottom to the top, the two ends of the connecting plate 564 are imported into the two guiding chutes, thus further limiting the position of the connecting plate 564.

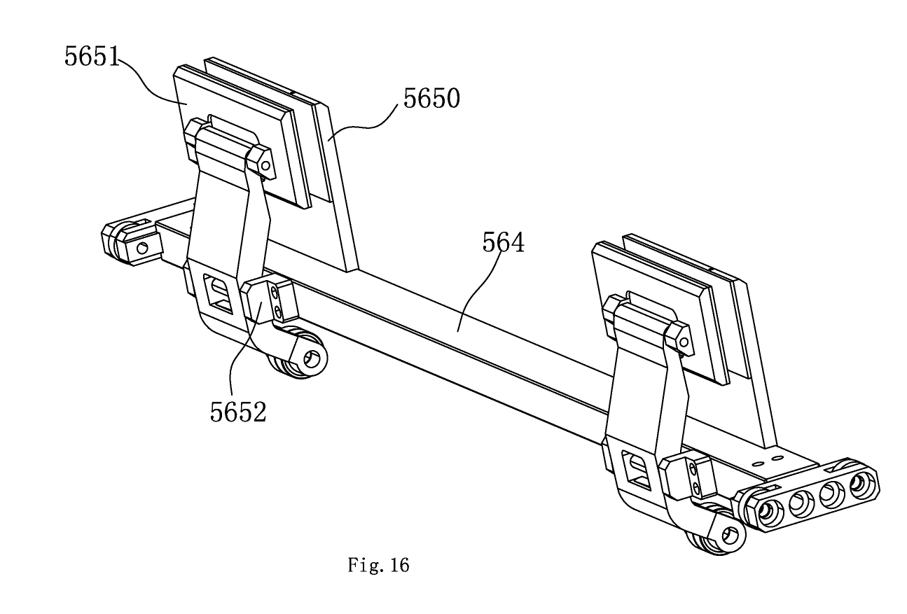

Further, referring to FIG. 16, one of the two limiting plates is a fixed splint 5650, and the other is an elastic splint 5651. Concretely, The fixed splint 5650 is fixed on the side of the connecting plate 564, the elastic splint 5651 is pivoted to the connecting block 5652 on the other side of the connection plate 564, and a torsion spring is arranged on the pivot shaft, the torsion spring pushes the elastic splint 5651 to clamp on the fixed splint 5650. A first open clamping mechanism 5653 and a second open clamping mechanism 5654 are arranged between the two mounting plates 560. The first open clamping mechanism 5643 opens the elastic splint 5651 of the positioning assembly 565 at the feeding position. When the the sprocket chain conveyors 562 drive the connecting plate 564 to the position of the loading and unloading manipulator 1100, the first open clamping mechanism 5653 opens the elastic splint 5651 at the position. Therefore, the batteries may be clamped and placed between the elastic splint 5651 and the fixed splint 5650, or the batteries between the elastic splint 5651 and the fixed splint 5650 may be clamped and placed on the conveying line 4. When the battery clamping mechanism 2 clamps the batteries on the feeding and positioning mechanism 5 and places them into the battery formation fixture 1. The second open clamping mechanism 5654 pushes all of the elastic splints 5651 at the upper end to open. Or when the batteries are needed to place on the unloading storage mechanism 6, the second opening mechanism 5654 pushes all of the elastic splints 5651 at the upper end to open.

Concretely, the elastic splint 5651 includes a rotating plate pivoted with the connecting block 5652, a floating splint plate rotatably connecting the upper end of the rotating plate, a roller provided at the lower end of the rotating plate. The first clamping mechanism 5653 includes a first supporting plate arranged between two of the mounting plates 560 and a first open clamping cylinder arranged at both ends of the first supporting plate and a pushing block arranged on the piston rod of the first open clamping cylinder. The first open clamping cylinder pushes the pushing block upward and the pushing block plucks the elastic splint 5641 to open around the pivot. The number of the second open clamping mechanism 5654 is 4 groups, and are set side by side. The second open clamping mechanism 5654 includes a second supporting plate arranged between two of the mounting plates, a second open clamping cylinder arranged at the two ends of the second supporting plate, and an opening clip plate connected with the piston rod of the two open clamps.

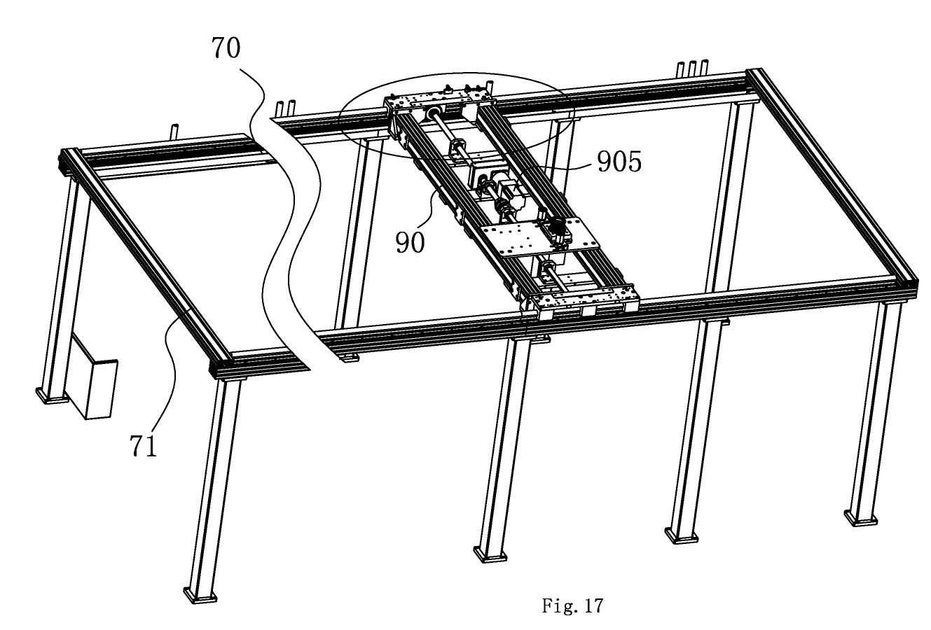

Referring to FIG. 17, the crossbeam frame 7 includes two supporting frames 70 arranged in parallel at the top of the base 1000, the two beams 71 are respectively connected at the two ends between the two supporting frames 70.

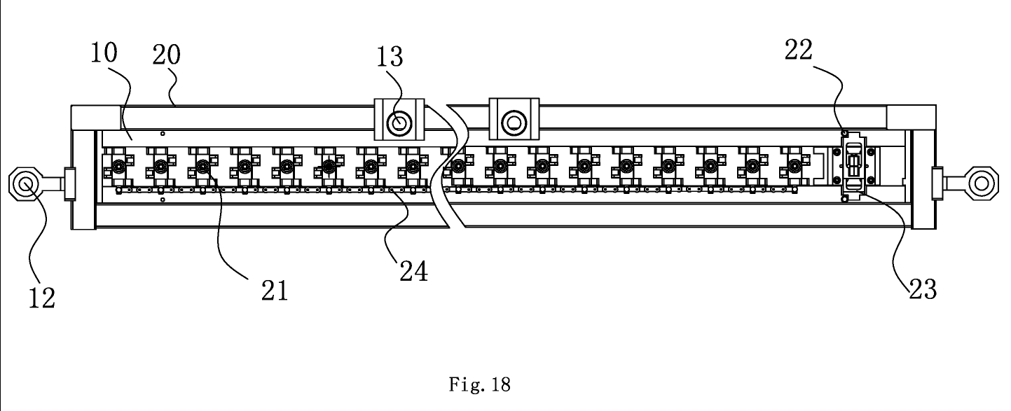

Referring to FIG. 18, the battery clamping mechanism 2 includes a frame 20, a clamping mechanism 21, a limiting pin 22, a limiting mechanism 23 and a chain 24. The number of clamping mechanisms 21 is plurality, distributed within the framework 20. The clamping mechanisms 21 at the front of the frame 20 are fixed to the framework 20. The clamping mechanisms 21, one side of which is provided with the limiting mechanism 23, at the back of the framework 20 are active fixed to the framework 20. The limiting pin 22 is located on the top surface at the end of the framework 20. All of the clamping mechanisms 21 are pivotally connected with the chain 24; The chain 24 pulls the active clamping mechanism 21 to slide within the frame 20.

Lithium battery formation fixture 1 is equipped with top rod. The opening clamp mechanism 9 clamps the battery clamping mechanism 2 and drives it to the upper end of the feeding and positioning mechanism 5, and the opening clamp mechanism 9 pull the clamping mechanism 20 to open, so that the clamping mechanism 20 can clamp the batteries on the feeding and positioning mechanism 5. the opening clamp mechanism 9 transports the lithium batteries to the upper end of the laminates 140 of the lithium battery formation fixture 1, and put the lithium batteries between the laminate 140. While the laminate 140 clamps the batteries, the clamping mechanism 21 is pulled to move at the same time, so that the clamping mechanism 21 can clamp the batteries all the time.

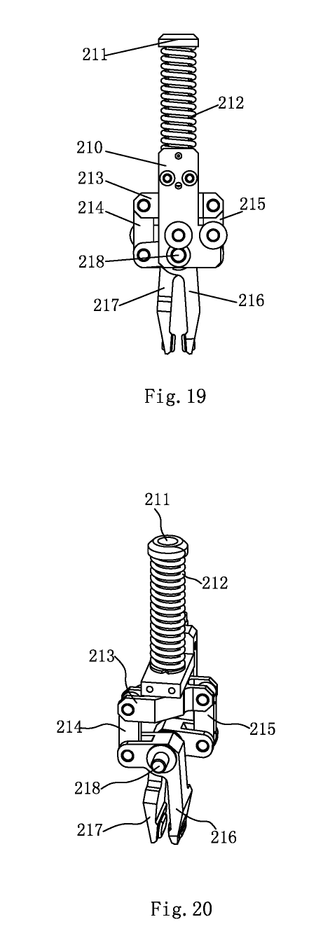

Referring to FIG. 19 and FIG. 20, the clamping mechanism 21 includes a connecting seat 210, a pushing rod 211, a spring 212, a connecting block 213, a first connecting rod 214, a second connecting rod 215, a first clamping jaw 216 and a second clamping jaw 217. The pushing rod 211 runs through the connecting seat 210. The upper end of the pushing rod 211 is provided with the limiting block 213. The spring 212 is set on the pushing rod 211, and the spring 212 is located between the limiting block 213 and the connecting seat 210. The connecting block 213 is arranged at the bottom end of the pushing rod 211; the first connecting rod 214 and the second connecting rod 215 are pivoted at the two ends of the connecting block 213 respectively. The first clamping jaw 216 is arranged at the lower end of the first connecting rod 214, the second clamping jaw 217 is arranged at the lower end of the second connecting rod 215, and the first clamping jaw 216 is pivoted with the first connecting rod 214. The second clamping jaw 217 is pivoted with the second clamping jaw 215. A shaft 218 passes through one side of the connecting seat 210, the first clamping jaw 216, the second clamping jaw 217 and the other side of the connecting seat 210. Both of the first clamping jaw 216 and the second clamping jaw 217 are rotatably connected with the shaft 218. Thus, by pushing the pushing rod 211, the connecting block 213 drive the first connecting rod 214 and the second connecting rod 215 to move downward, the first clamping jaw 216 and the second clamping jaw 217 rotate around the shaft 218, thereby opening the first clamping jaw 216 and the second clamping jaw 217.

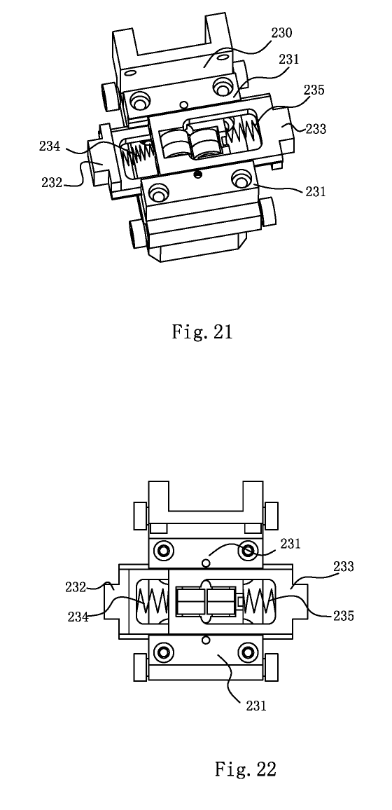

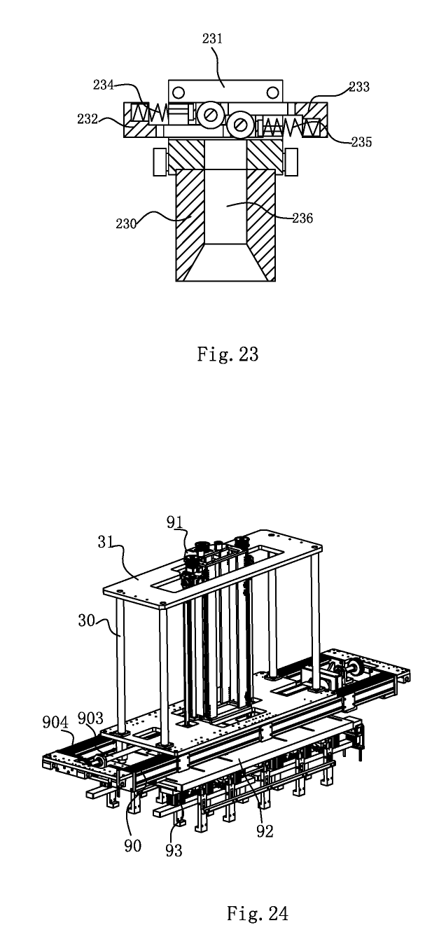

Referring to FIG. 21, FIG. 22 and FIG. 23, the limiting mechanism 23 includes: a mounting seat 230, two guiding and limiting blocks 231, a first limiting block 232, a second limiting block 233, a first resetting spring 234 and a second resetting spring 235. The mounting seat 230 is located on one side of the clamping mechanism 21. The two guiding and limiting blocks 231 are arranged opposite to the two sides of the upper end of the mounting seat 230. The first limiting block 232 and the second limiting block 233 are superimposed between the two guiding limiting blocks 231. Both of the outer side of the first limiting block 232 and the outer side of the second limiting block 233 are provided with a limiting lug. The first limiting block 232 and the second limiting block 233 are provided with the first pushing chute and the second pushing chute respectively, the end of the first pushing chute overlaps with the end of the second pushing chute. The first resetting spring 234 is arranged in the first pushing chute; the second resetting spring 235 is arranged in the second pushing chute. The first resetting spring 234 extrudes the second limiting block 233, and the second resetting spring 235 extrudes the first limiting block 232. The mounting seat 230 is provided with a socket 236 at the lower end of the overlap portion of the first pushing chute and the second pushing chute. Therefore, a pin is arranged at the top of the movable laminate 140 in the lithium battery formation fixture 1. After the opening clamp mechanism 9 places the battery clamping mechanism 2 clamping with the batteries on the lithium battery formation fixture 1, the pin is inserted through the socket 236 into the overlap position of the first pushing chute and the second pushing chute so that the first limiting block 232 and the second limiting block 233 are extruded to slide inward, The first limiting block 232 and the second limiting block 233 are separated from the limiting pin 22, thereby enabling the active clamping mechanism 21 to move in the direction of the fixed clamping mechanism 21, thereby realizing that the clamping mechanism 21 clamps the batteries, at the same time the battery clamping mechanism 2 always can also clamp the batteries too.

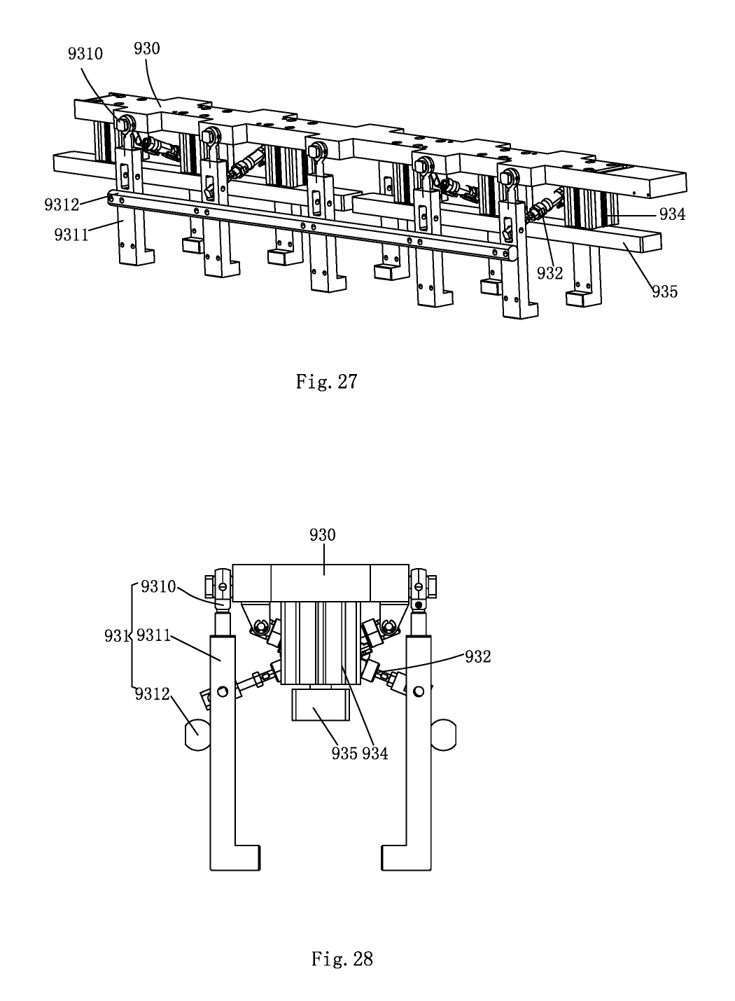

Referring to FIG. 17, FIG. 24, FIG. 26, FIG. 27 and FIG. 28, the opening clamp mechanism 9 comprises a mobile frame 90 and a lifting mechanism 91 provided on the mobile frame 90. The lifting mechanism 91 drives a second mounting plate 92 which is located at the bottom end of the mobile frame 90 to move up and down; the bottom end of the second mounting board 92 is provided with a clamping mechanism 93. The clamping mechanism 93 comprises a mounting block 930 arranged at the bottom end of the second mounting plate 92, the two sides of the mounting block 930 are respectively provided with a retractor assembly 931. The bottom end of the mounting block 930 is provided with a driving mechanism 932 that pushes the two retractor assemblies 931 to swing to the two sides respectively. The bottom end of the mounting block 930 is also provided with a pushing and pressing mechanism 932 which pushes the clamping mechanism 2 to open. The two ends of the mobile rack 90 are respectively located at the top of the two supporting frames 70. The pushing mechanism 932 drives the two retractor assemblies 931 to swing to the two sides respectively, so that the two retractor assemblies 931 open to the two sides. The second mounting plate 92 and the clamping mechanism 93 are driven down by the lift mechanism 91 so that the two retractor assemblies 931 are positioned on either side of the frame of the battery formation fixture. Then the pushing and pressing mechanism 932 pulls the two retractor assemblies 931 back to the original position so that the frame 20 is clamped by the retractor assemblies 931 on both sides.

Referring to FIG. 27 and FIG. 28, multiple open-clamped cylinders 934 are arranged at the bottom of mounting block 930, a pushing plate 935 connects with the piston rods of multiple open-clamped cylinders 934. The battery clamping mechanism 2 pushes the pushing rod 211 when the batteries need to be clamped or loosen, and the open-clamped cylinders 934 push the pushing plate 935 downward so that the pushing rod of the push clamping mechanism 21 moves downward. The connecting block push the first connecting rod 214 and the second connecting rod 215 to move downward so that the first clamping jaw 216 and the second clamping jaw 217 rotate around the shaft 218 and are opened. When the clamping mechanism 21 is needed to be clamped, the pushing mechanism 932 is separated from the clamping mechanism 210, and the first clamping jaw 216 and the second clamping jaw 217 are reset under the action of the spring 212, so that the clamping mechanism can hold the batteries.

The retractor assembly 931 includes a plurality of universal joints 9310 arranged on the side of the mounting block 930, retractors 9311 arranged at the bottom of the universal joint 9310 and a connecting rod 9312 connecting the plurality of the retractors 9311 together. Therefore, the retractor assembly 931 can swing with driving from the pushing mechanism 932.

The retractors 9311 are symmetrically arranged on both sides of the mounting block 930. The pushing mechanism 932 are a plurality of pushing cylinders intersected in turn, and one end of the pushing cylinders are rotatably connected to the mounting block 40 and the other end of the pushing cylinders are rotatably connected with the corresponding retractor 9311.

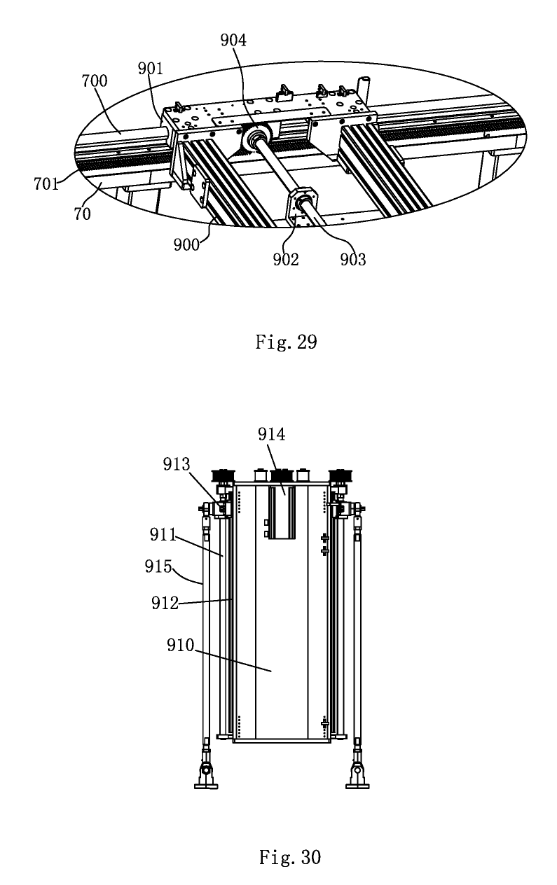

Referring to FIGS. 17 and 29, the top face of the supporting frame 70 is arranged parallel with the guiding rail 700 and the rack 701. The mobile frame 90 includes a moving seat 900, a sliding block 901 set at the bottom of the two sides of the moving seat 900 and slid connected with the guiding rail 700. A plurality of housing seats 902 are arranged on the top of the moving seat 900, and a rotary shaft 903 passes through the bearing of the plurality of bearing seats 902. Both ends of the rotary shaft 903 are provided with a gear 904, and the two gears 904 are engaged with the rack 701 on the two supporting frames 70, respectively. A deceleration motor assembly 905 arranged on the moving seat 900 drives the rotary shaft 903 to rotate; thereby, the gear 904 is rotated, The gear 904 meshes with the rack 701, so that the moving seat 900 slides along the guiding rail 700. Concretely, the deceleration motor assembly 905 includes a gear motor mounted on the moving seat 900, a driven synchronous wheel tightly mounted on the shaft 903 of the gear motor, and a synchronous belt around the active synchronous wheel and the driven synchronous wheel.

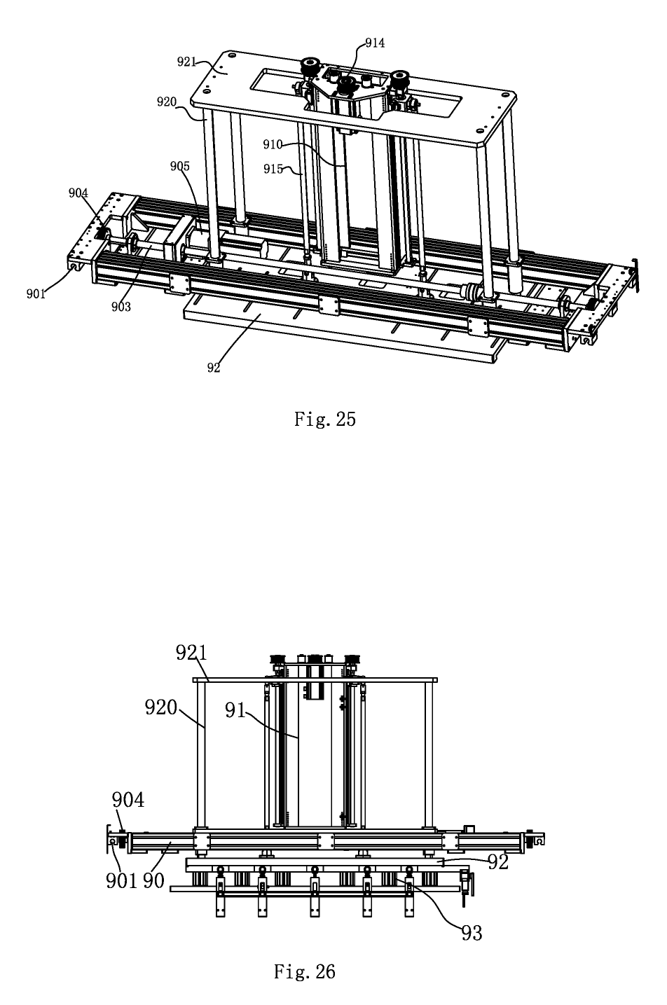

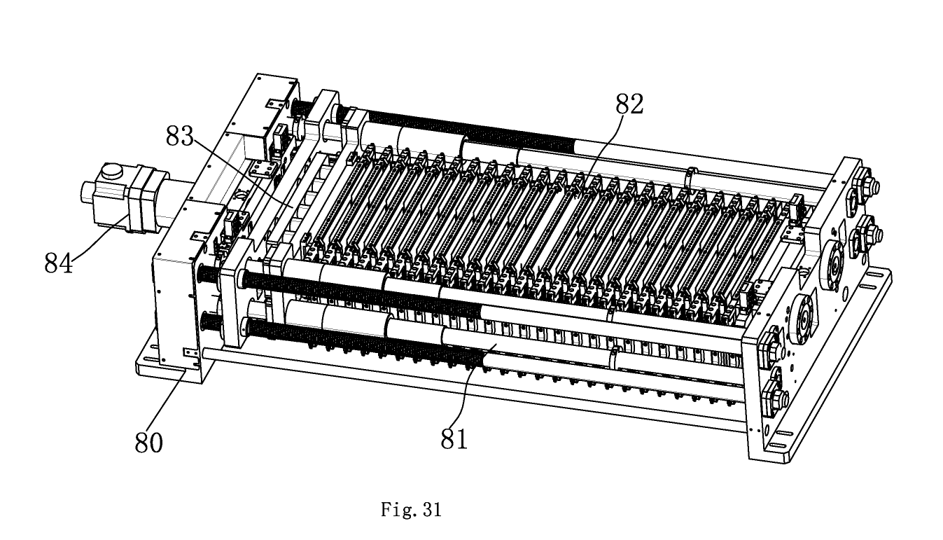

Referring to FIG. 24, FIG. 25, FIG. 26 and FIG. 30, the lifting mechanism 91 includes a supporting seat 910 arranged on the mobile rack 90, a wire rod 911 and a guiding rail 912 arranged opposite to the two sides of the supporting seat 910, a nut 913 is arranged on the wire rod 91. The driving mechanism 914 arranged on the supporting seat 910 drives the two wire rods 911 to rotate clockwise or counterclockwise at the same time, making the two nuts 913 to slide up and down along the corresponding rail 912 respectively. The nut 913 is provided with a connecting rod 915 connected with the mounting plate 92. Therefore, the upper and lower motion of the driving mounting plate 92 can be realized.

All of the four diagonal positions of the mounting plate 92 are also provided with a guiding post 920 running through the moving frame 90. A connecting plate 921 is connected to the upper ends of the four guiding posts 920. When the lifting mechanism 91 drives the second mounting plate 92 to move up and down, the guiding posts 920 play a guiding role. The connecting rod 915 is connected with the nut 923 through the second universal junction. The driving mechanism 914 comprises driven synchronous wheels respectively arranged on two wire rod 911, a lifting motor arranged on the support seat 910 and an active synchronous wheel mounted on the main shaft of the lifting motor 2, and s synchronous band wound around the active synchronous wheel and the two driven synchronous wheels (not shown).

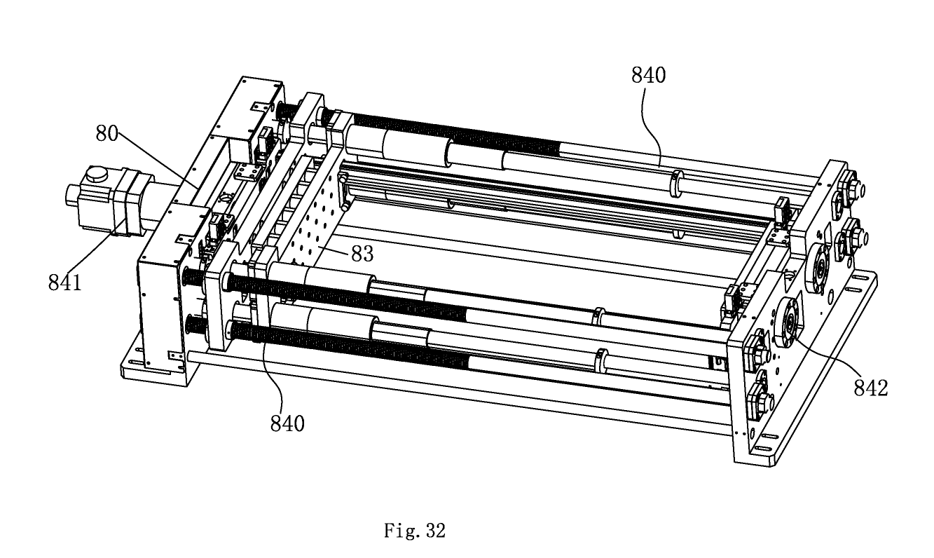

Referring to FIGS. 31 and 32, the cold pressing fixture 8 includes two opposite sets of second mounting seat 80, four sets of second guiding rods 81 between the two second mounting seats 80, a plurality of groups of cold pressed laminates 82 and a second compacting assembly 83 arranged on four groups of second guiding rods 81, a second pushing mechanism 84 arranged on the second mounting seat 80. The second pushing mechanism 84 drives the second compacting assembly 83 to slide along the second guiding rods 81 so that the batteries are pressed between the adjacent two cold pressed laminates 82. The cold pressed laminate 82 is provided with a circulating water circuit connected with the water cooling system. It cools the batteries after the realization of the formation of the batteries.

The four sets of second guiding rods 81 are symmetrically arranged in four diagonal positions between two second mounting blocks 80. The second pushing mechanism 84 comprises four sets of second wire pairs 840 which rotatably connected between two of the second mounting seats 80, the second servo motor driving mechanism 841, which is arranged on one of the second mounting seats 80, simultaneously drives four groups of the second wire rod pair 840 to run. And the second servo motor driving mechanism 841 and the servo motor driving mechanism 131 have the same structure. The other of the second mounting seat 80 is provided with second pressure sensor 842. Concretely, The second servomotor driving mechanism 841 drives four of the second wire rod pairs 840 to rotate with the same direction at the same time, which causes the second compacting assembly 83 to move, thus pushes the cold-pressed laminates 82 to extrude the batteries so as to reduce the heat of the batteries. Concretely, the structure of the second compacting assembly 83 is the same as that of the first compacting assembly.

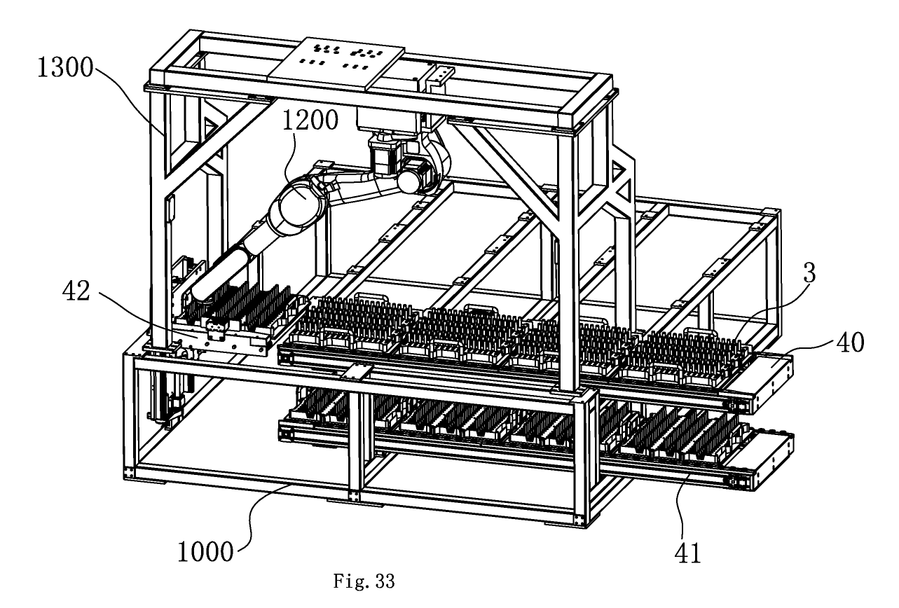

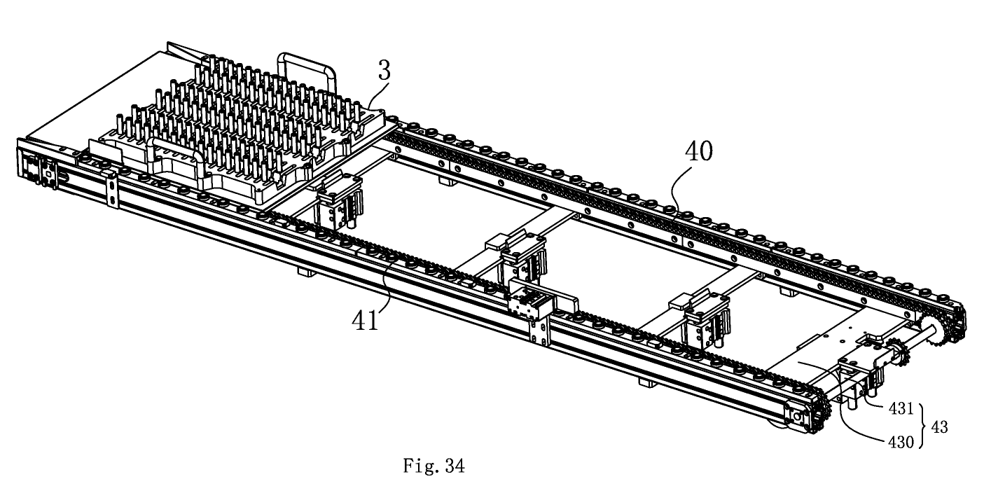

Referring to FIG. 33 and FIG. 34, the conveying line 4 includes a first chain conveyor 40 and a second chain conveyor 41 arranged parallel up and down, and a lifting conveyor 42 connecting the first chain conveyor 40 and the second chain conveyor 41. A pneumatic positioning assembly 43 is arranged at the end of the first chain conveyor 40. Concretely, the first chain conveyor 40 and the second chain conveyor 41 is fixed with the machine seat. The lifting conveyor 42 is located at the top end of the first chain conveyor 40. when the material carrier 3 loaded with materials is placed on one end of the first chain conveyor 40, it is conveyed from one end to the other end by the first chain conveyor 40 and positioned by the pneumatic positioning assembly 43, so that is is convenient for the loading and unloading manipulator 1100 to clamp the batteries loaded in the material carrier 3 and place into the feeding and positioning mechanism 5. Or when the batteries in the unloading storage mechanism 6 is placed in the material carrier 3, the pneumatic positioning assembly 43 moves downward, and the first chain conveyor 40 conveys the material carrier 3 to the lifting conveyor 42, the lifting conveyor 42 drives the material carrier 43 to move downward and transfers to the second chain conveyor 41.

Referring to FIG. 34 the pneumatic positioning assembly 43 includes a connecting and supporting plate 430 arranged near the bottom of one end of the first chain conveyor 40 next to the end of the lifting conveyor 42, and a positioning cylinder 431 arranged on the connecting and supporting plate 430. Concretely, the connecting and supporting plate 430 is fixed to the mounting frame of the first chain conveyor 40. When the first chain conveyor 40 conveys the material carrier 3 to the end, the positioning cylinder 431 is ejected upward to limit the position of the material carrier 3.

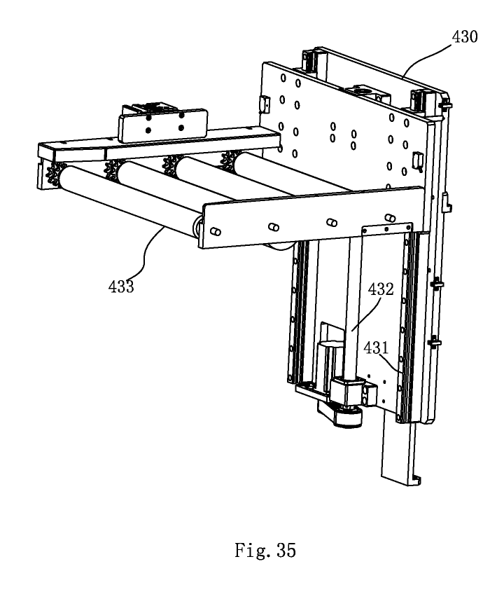

Referring to FIG. 35, the lifting conveyor 42 includes a vertical plate 420 fixed to the base 1000, two linear guiding rails 421 arranged on the side of the vertical plate 420, a lifting plate 422 connecting the two linear guiding rails 421, and a lifting plate 422 moving up and down along the two straight guiding rails 421, the electric wire rod mechanism 423 pushing the lifting plate 422 to move up and down along two of the straight guiding rails 421, and a transferring chain conveyor 424 provided on the side of the lifting plate 422.

Referring to FIG. 12, FIG. 13 and FIG. 33, the loading and unloading manipulator 1100 is a six-axis manipulator. The top of the base 1000 is also provided with a positioning and supporting seat 1200 for placing the battery clamping mechanism. The feeding and positioning mechanism 5, the positioning supporting seat 1200, the unloading storage mechanism 6, three groups of the lithium battery formation fixtures 1 and one group of the cold pressing fixture 8 are arranged in turn along the moving direction of the opening clamp mechanism 9 on the crossbeam frame 7. The feeding and positioning mechanism 5 and the unloading storage mechanism 6 are located on one side of the conveying line 4. Concretely, all of the three groups of lithium battery formation fixtures 1 and the group of cold pressing fixture 8 have a battery clamping mechanism 2. The opening clamp mechanism 9 holds the battery clamping mechanism 2, which clamps the batteries and transports to the next station, and both of the batteries and the battery clamping mechanism 2 stop at the station. After the batteries in the cold pressing fixture 8 are clamped to the unloading storage mechanism 6, the opening clamp mechanism 9 clamps the battery clamping mechanism 2 into the positioning supporting seat 1200 for transfer. Thus, the cycle can be realized.

The invention is not limited to the specific embodiment of the invention, and the ordinary technicians in the field proceed from the above idea, do not go through creative labor, and make all kinds of changes, all of which fall into the protection scope of the invention.

We claim:

1. A lithium battery formation fixture includes two opposite supporting seats, a plurality of guiding pillars arranged between said supporting seats and a compressing assembly arranged on said plurality of guiding pillars, a pushing mechanism is arranged on said supporting seats and drives said compressing assembly to slide along said guiding pillars, wherein a plurality of forming laminate assemblies are arranged between two of said supporting seats, PCB board assemblies bonding to electrode ears of lithium batteries are arranged on said forming laminate assemblies, and an adjusting mechanism is arranged between said two supporting seats to adjust upper and lower position of said forming laminate assemblies and said PCB board assemblies.

2. The lithium battery formation fixture according to claim 1, wherein said adjusting mechanism comprises: two adjusting assemblies, two connecting and sliding rails and two connecting and guiding rails, said two adjusting assemblies are respectively fixed to said inner sides of said two supporting seats, said adjusting assembly comprises a first adjusting plate, a first guiding rail, a fixed nut, a first wire rod, a first driving mechanism, two second guiding rails, a second adjusting plate, a movable nut, a second wire rod and a second driving mechanism; said first guiding rail is arranged at said inner side of said supporting seat and slid fits with said first adjusting plate; said fixed nut is arranged on said inner side of said supporting seat, and said first wire rod passes through said bottom of said first adjusting plate and said fixed nut in turn; said first wire rod is rotatably connected with said first adjusting plate and is matched with said fixed nut; said two second guiding rails are arranged on both sides of said first adjusting plate, and said second adjusting plate is arranged on said two second guiding rails; said movable nut is fixed on said second adjusting plate, said second wire rod is matched with said moving nut and rotatably connected with said first adjusting plate; said first driving mechanism drives said first wire rod to rotate, so that said first adjusting plate slides up and down along said first guiding rail, and said second driving mechanism drives said second wire rod to rotate, so that said second adjusting plate slides up and down along said second guiding rail; said two ends of said two connecting and sliding rails are respectively fixed to both of said first adjusting plates; said two ends of said two connecting and guiding rails are respectively fixed to both of said second adjusting plates; said two sides of said upper ends of said forming laminate assemblies are respectively arranged on said two connecting and sliding rails; said PCB board assemblies on said forming laminate assemblies are arranged on said connecting and guiding rail.

3. The lithium battery formation fixture according to claim 2, wherein said forming laminate assembly comprises a laminated plate, a connecting member arranged at both ends of said laminate plate, and a block arranged on said inner side of said laminated plate; when said pushing mechanism pushes said compressing assembly to press said plurality of laminate plates against said lithium batteries, said blocks compact said polar ears of said lithium batteries on said PCB board assemblies at said side of said adjacent forming laminate assemblies; said upper end of said connecting member is provided with a roller, and said lower end of said connecting member is provided with a guiding chute; said roller slides along said guiding chute on said top of said connecting and sliding rail; said PCB board assembly includes a slider mounted on said connecting and guiding rail and a PCB board fixed to said slider; said second driving mechanism drives said second adjusting plate to slide along said second guiding rail; said connecting and guiding rail pushes said slider to slide along said guiding chute; said laminated plate is also provided with a limiting step hole, and said PCB board is provided with a limiting pin running through said limiting step hole.

4. The lithium battery formation fixture according to claim 3, wherein the inner side of said connecting and sliding rail is also provided with a support chute, and the outside of said connecting member is provided with a supporting roller extending into said supporting chute.

5. The lithium battery formation fixture according to claim 2, wherein said first adjusting plate also provided with a first hole and a second hole; said fixing nut is located in said first hole and said movable nut is located in said second hole; the lower end of said first wire rod is also covered with a connecting block, said connecting block is fixed at the bottom of said first adjusting plate; the upper end of said first wire rod is rotatably connected with said first adjusting plate and the lower end of said first wire rod is rotatably connected with said connecting block.

6. The lithium battery formation fixture according to claim 5, wherein said first driving mechanism includes a first mounting seat arranged at the bottom end of said first adjusting plate, a first driving motor arranged on said first mounting seat, and a chain driving mechanism, a gear driving mechanism or a synchronous wheel driving mechanism arranged between said shaft of the first driving motor and said first wire rod; said second driving mechanism includes a second mounting seat arranged on said bottom end of said first adjusting plate, a second driving motor arranged on said second mounting seat, and a chain driving mechanism, a gear driving mechanism or a synchronous wheel driving mechanism arranged between the shaft of said second motor and said second wire rod.

7. The lithium battery formation fixture according to claim 1, wherein said pushing mechanism includes four sets of wire rod pairs that are rotatably connected between said two supporting seats, a servo motor driving mechanism which is arranged on one of said supporting seat and simultaneously drives four groups of said wire rod pairs to run; the other of the supporting seat is provided with a pressure sensor; said compressing assembly includes guiding sleeves sliding along said guide pillars, a pushing plate connected with said guiding sleeves, a driving and mounting assembly tightly coupled with said nuts of said wire rod pairs, and a pressurized cylinder arranged on said driving and mounting assembly; said pressurized cylinder is connected with said air pressure adjusting laminate by pipeline; said piston rod of said pressurized cylinder runs through said driving and mounting assembly; said servo motor driving mechanism drives said wire rod pairs to run so that said compressing assembly pushes said adjacent laminate assemblies to press said lithium batteries, and said pressurized cylinder pushes said pushing plate to slide and compact said batteries along said guiding pillars.

8. An automation battery formation equipment with said lithium battery formation fixture according to claim 1, wherein includes a battery clamping mechanism and a base; said base is provided with a conveying line for conveying said material carrier, a feeding and positioning mechanism for storing and locating said batteries before formation, an unloading storage mechanism for said battery temporarily stored after said formation, a crossbeam frame, a cold pressing fixture and a loading and unloading manipulator; said loading and unloading manipulator is arranged above said conveying line; said crossbeam frame is provided with an opening clamp mechanism; said feeding and positioning mechanism, said unloading storage mechanism, said lithium battery formation fixture and said cold pressing fixture are arranged along the moving direction of said opening clamp mechanism; said conveying line conveys said material carrier which contains batteries to be formed to the lower part of said loading and unloading manipulator, said loading and unloading manipulator transfers said batteries on said material carrier into said feeding and positioning mechanism; said opening clamp mechanism clamps and opens said battery clamping mechanism, which clamps said batteries positioned in said feeding and positioning mechanism into said lithium battery formation fixture.

9. The automation battery formation equipment according to claim 8, wherein both of said feeding and positioning mechanism and said unloading storage mechanism are chain-type conveying and positioning mechanism, which includes two mounting plates arranged opposite to said base, two rotating shafts arranged between said two mounting plates, two sprocket chain conveyors arranged between said two rotating shafts, and a second driving mechanism arranged on said mounting plates and driving said sprocket chain conveyors to run, a plurality of connecting plates arranged between said chains of said two sprocket chain conveyors, and a positioning assembly arranged on said connecting plate.

10. The automation battery formation equipment according to claim 8, wherein said crossbeam frame includes two supporting frames arranged in parallel at the top of said base and two beams connected said two supporting frames; said two beams are respectively connected at the two ends of said two supporting frames;
said battery clamping mechanism includes a frame, clamping mechanisms, a limiting pin, a limiting mechanism and a chain; the number of clamping mechanisms is plurality, distributed within said framework; said clamping mechanisms at said front of said frame is fixed to said frame, said clamping mechanisms, one side of which is provided with a limiting mechanism, arranged at the end of said frame are active fixed to said frame; said limiting pin is located on said top surface at said end of said frame; a plurality of said clamping mechanisms are pivotally connected with said chain; said chain pulls said clamping mechanism to slide within said frame;
said opening clamp mechanism comprises a mobile frame and a lifting mechanism provided on said mobile frame; said lifting mechanism drives a second mounting plate which is located at the bottom end of said mobile frame to move up and down; the bottom end of said second mounting plate is provided with a clamping mechanism; said clamping mechanism comprises a mounting block arranged at the bottom end of said second mounting plate, the two sides of said mounting block are respectively provided with a retractor assembly; the bottom end of said mounting block is provided with a driving mechanism that pushes said two retractor assemblies to swing to the two sides respectively; the bottom end of said mounting block is also provided with a pushing and pressing mechanism which pushes said clamping mechanism to open; the two ends of said mobile rack are respectively located at the top of said two supporting frames.

11. The automation battery formation equipment according to claim 10, wherein the top face of said supporting frame is arranged parallel with said guiding rail and said rack; said mobile frame includes a moving seat, a sliding block is set at the bottom of said moving seat ends and connected with said guiding rail; a plurality of housing seats are arranged on the top of said moving seat, and a rotary shaft passes through the bearing of said plurality of bearing seats; both ends of said rotary shaft are provided with a gear, and said two gears are engaged with said rack on said two supporting frames, respectively; a deceleration motor assembly arranged on said moving seat drives said rotary shaft to rotate.

12. The automation battery formation equipment according to claim 8, wherein said cold pressing mechanism includes two opposite sets of said second mounting seat, four sets of second guiding rods arranged between said two second mounting seats, a plurality of groups of cold pressed laminates and a second compressing assembly arranged on four groups of second guiding rods, a second pushing mechanism arranged on the second mounting seat; said second pushing mechanism drives said second compressing assembly to slide along said second guiding rod so that said batteries are pressed between said adjacent two cold pressed laminates; said cold pressed laminate is provided with a circulating water circuit connected with said water cooling system.

13. The automation battery formation equipment according to claim 8, wherein said conveying line includes a first chain conveyor and a second chain conveyor arranged parallel up and down, and a lifting conveyor connecting said first chain conveyor and said second chain conveyor; a pneumatic positioning assembly is arranged at said end of said first chain conveyor.

14. The automation battery formation equipment according to claim 8, wherein said loading and unloading manipulator is a six-axis manipulator; the top of said base is also provided with a positioning and supporting seat for placing said battery clamping mechanism; said feeding and positioning mechanism, said positioning and supporting seat, said unloading storage mechanism, three groups of said lithium battery formation fixtures and one group of said cold pressing fixture are arranged in turn along the moving direction of said opening clamp mechanism on said crossbeam frame; said feeding and positioning mechanism and said unloading storage mechanism are located on one side of said conveying line.
